(19) United States
(12) Patent Application Publication
(10) Pub. No.: US 2015/0305967 A1
(43) Pub. Date: Oct. 29, 2015

(54) Massage Table System and Method

(71) Applicant: Colby Harper O'Neal, Bedford, TX (US)

(72) Inventor: Colby Harper O'Neal, Bedford, TX (US)

(21) Appl. No.: 14/264,478

(22) Filed: Apr. 29, 2014

(51) Int. Cl. A61H 15/00

(52) U.S. Cl. CPC A61H 15/00

(57) ABSTRACT

A massage table system/method allowing self-application of adjustable compression and stretching is disclosed. The system incorporates a frame support structure (FSS) horizontally supporting a patient support table (PST) and patient face cradle (PFC) permitting a massage patient to receive adjustable massage from a body contact assembly (BCA) positioned using a horizontal slide assembly (HSA) under pneumatic control of a horizontal cylinder assembly (HCA). The patient is massaged via a patient massage roller (PMR) radially articulated by the BCA in response to pneumatic pressure applied by a vertical cylinder assembly (VCA) while the BCA is positioned longitudinally over the patient by the HSA. A control interface box (CIB) provides adjustment of HSA travel speed, position, and applied pressure to the PMR by the VCA. Computer controls within the CIB may permit automated patient massage procedures by pre-programmed/memorized operation of pneumatic valves controlling the HSA and BCA.

### CROSS REFERENCE TO RELATED APPLICATIONS

Not Applicable

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention generally relates to systems and methods for providing therapeutic massage. While not limitive of the invention scope, various embodiments of the present invention may in some circumstances be categorized under U.S. Patent Classifications 128/24, 33, 44, 46, 49, 51-53, 55, 57-58, 60-61; and 901/14, 17.

### PRIOR ART AND BACKGROUND OF THE INVENTION

The present invention relates to massage therapy by means of compression and/or stretching of the human body. The benefits of deep tissue compression and stretching have long been known by those skilled in the art. Many well-known methods and devices of prior art have been developed to apply this type of therapy.

Massage is one of the oldest therapies and has been around for thousands of years. Various forms are practiced and many devices have been developed to perform massage. Among the vast array of methods and devices to choose from, many patients prefer deep tissue compression and stretching massage. Some of the benefits of this type of therapy include:
Relieving myofascial pain;
Boosting nerve function and blood circulation;
Softening & lengthening muscles;
Increasing freedom of movement;
Accelerating muscle healing and recovery; and
Feeling rejuvenated.
   Although many prior art methods and devices provide some degree of deep tissue therapy, none offer the advantages of a coordinated massage that includes compression and stretching. Prior art examples and their disadvantages are presented below.

### Intersegmental Traction Machines (or Roller Tables)

In these massage systems a patient lies face-up on a table while a set of rollers move underneath the patient while they are lying on top of the table face up. Disadvantages to this architecture include:
Higher pressure can lift the patient body;
Inability to apply static pressure;
Contact point continually changes; and
Small contact point (may only use narrow rollers because the patient's body has to be supported by the table).

### Foam Rollers

The patient's muscles tense up, defeating the purpose of the massage.
The only pressure setting is the patient's weight at lower back and roughly half their body weight at upper back.

### Therapist Massage Techniques

A variety of therapist assisted massage techniques exist (barefoot (Ashiatsu), Shiatsu, Swedish Massage, etc.), but suffer from the following drawbacks:
Requires a therapist;
Patient isn't in control; and
Physically demanding on therapist.

### Aqua Massage

Can only apply light pressure; and
High maintenance.

### Massage Chairs

Can only offer light pressure; and
Small contact point.

### U.S. Pat. No. 4,875,470 (0100)

As generally depicted in FIG. 1 (0100), U.S. Pat. No. 4,875,470 (circa 1989) describes a massage table that supports the patient and provides for controlled massage under direction of pneumatic cylinders. However, this system suffers from the following deficiencies:
Pneumatic cylinders are not controllable in this design and thus there is no methodology of controlling the pressure exerted on the patient.
Table is not integrated into the overall massage system and therefore the system is not portable or amenable to space-constrained environments.
Patient is not in control of the massage operation.

### U.S. Pat. No. 4,984,569 (0200)

As generally illustrated in FIG. 2 (0200), U.S. Pat. No. 4,984,568 (circa 1991) illustrates a massage table with the patient facing down but lacks a coordinated control and monitoring system to provide for repeatable massage treatments to the patient.

### U.S. Pat. No. 5,022,386 (0300)

As generally illustrated in FIG. 3 (0300), U.S. Pat. No. 5,022,386 (circa 1991) illustrates a face-down patient massage table employing mechanical pressure rollers. A major deficiency in this design is the inability to control the pressure applied to the patient during the massage treatments.

### Deficiencies in the Prior Art

The prior art as detailed above suffers from the following deficiencies:
The prior art lacks the ability to apply compression and stretching with the same treatment.
The prior art lacks the ability to enable the patient or therapist to perform the massage.
The prior art lacks the ability to monitor the pressure applied to the patient.
The prior art lacks the ability to automatically repeat massage therapy treatments.
The prior art lacks the ability to automatically record massage therapy treatments for reuse on the same patient.
The prior art lacks the ability to store and retrieve prerecorded massage therapy treatments for use on the patients.
The prior art lacks the ability to apply controlled and monitored static pressure to a patient.
The prior art lacks the ability to vary the applied pressure from very light to deep within a given treatment program.
The prior art lacks the ability to vary the speed of the treatment program from slow to fast.
The prior art lacks the ability to apply treatment to a large area body contact point.
The prior art lacks the ability to accommodate various sized patients.

While some of the prior art may teach some solutions to several of these problems, the core deficiencies in the prior art systems have not been addressed.

### OBJECTIVES OF THE INVENTION

Accordingly, the objectives of the present invention are (among others) to circumvent the deficiencies in the prior art and affect the following objectives:
(1) Provide for a massage table system and method that is portable.
(2) Provide for a massage table system and method that has the ability to apply compression and stretching with the same treatment.
(3) Provide for a massage table system and method that enables the patient or therapist to perform the massage.
(4) Provide for a massage table system and method that has the ability to monitor the pressure applied to the patient.
(5) Provide for a massage table system and method that has the ability to automatically repeat massage therapy treatments.
(6) Provide for a massage table system and method that has the ability to automatically record massage therapy treatments for reuse on the same patient.
(7) Provide for a massage table system and method that has the ability to store and retrieve prerecorded massage therapy treatments for use on the patients.
(8) Provide for a massage table system and method that has the ability to apply controlled and monitored static pressure to a patient.
(9) Provide for a massage table system and method that has the ability to vary the applied pressure from very light to deep within a given treatment program.
(10) Provide for a massage table system and method that has the ability to vary the speed of the treatment program from slow to fast.
(11) Provide for a massage table system and method that has the ability to apply treatment to a large area body contact point.
(12) Provide for a massage table system and method that has the ability to accommodate various sized patients.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

The present invention relates to self-applied or therapist-applied deep tissue therapeutic massage to the human body by means of compression and/or stretching. The system permits a massage therapy patient to lie face down on a patient support table (PST) with their face positioned in an adjustable patient face cradle (PFC) and hands on control interface box (CIB).

Once the patient has been positioned, the patient or massage therapist may control the horizontal movement of a body contact assembly (BCA) that includes a patient massage roller (PMR) comprising a roller, pad, or any variation thereof. The BCA is configured to move horizontally across the prone-positioned patient by means of a horizontal slide assembly (HSA) that is positioned pneumatically via the use of a horizontal cylinder assembly (HCA). The horizontal speed of the BCA is primarily determined by the HCA pneumatics cylinder and further modulated with a liquid damper cylinder to provide precise horizontal placement speed control. The downward massage pressure applied by the PMR to the patient may be controlled by the patient or therapist by means of adjusting a pneumatic regulator or throttling a manual pneumatic valve that controls a vertical cylinder assembly (VCA) that is attached to the PMR and radially articulated by the BCA as it traverses along the HSA. Control of the HCA and VCA is accomplished via a control interface box (CIB) that may be adjusted in position to affect operation by either the massage patient or massage therapist.

Various alternative embodiments may incorporate computer controls within the CIB to affect execution of pre-programmed massage therapies as well as storage/retrieval of manually implemented massage programs defined by the patient and/or therapist. Repetition/delay associated with various massage programs is anticipated within this automated control methodology.

### BRIEF DESCRIPTION OF THE DRAWINGS

For a fuller understanding of the advantages provided by the invention, reference should be made to the following detailed description together with the accompanying drawings wherein:

FIG. 1 illustrates a prior art massage table depicted in U.S. Pat. No. 4,875,470;

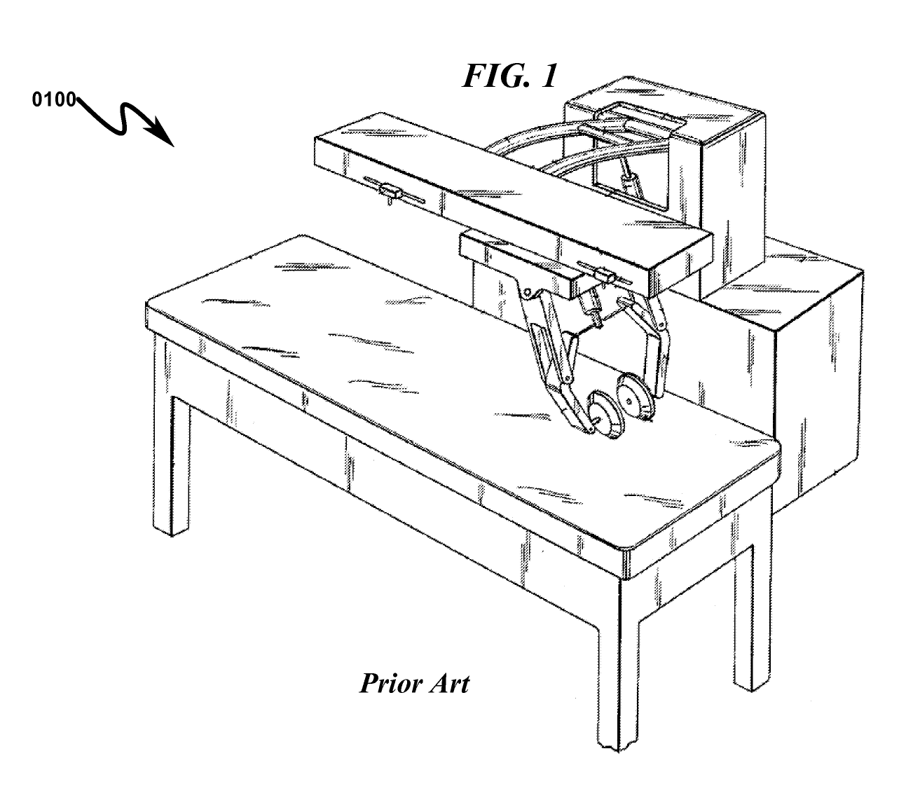

FIG. 2 illustrates a prior art massage table depicted in U.S. Pat. No. 4,984,568;

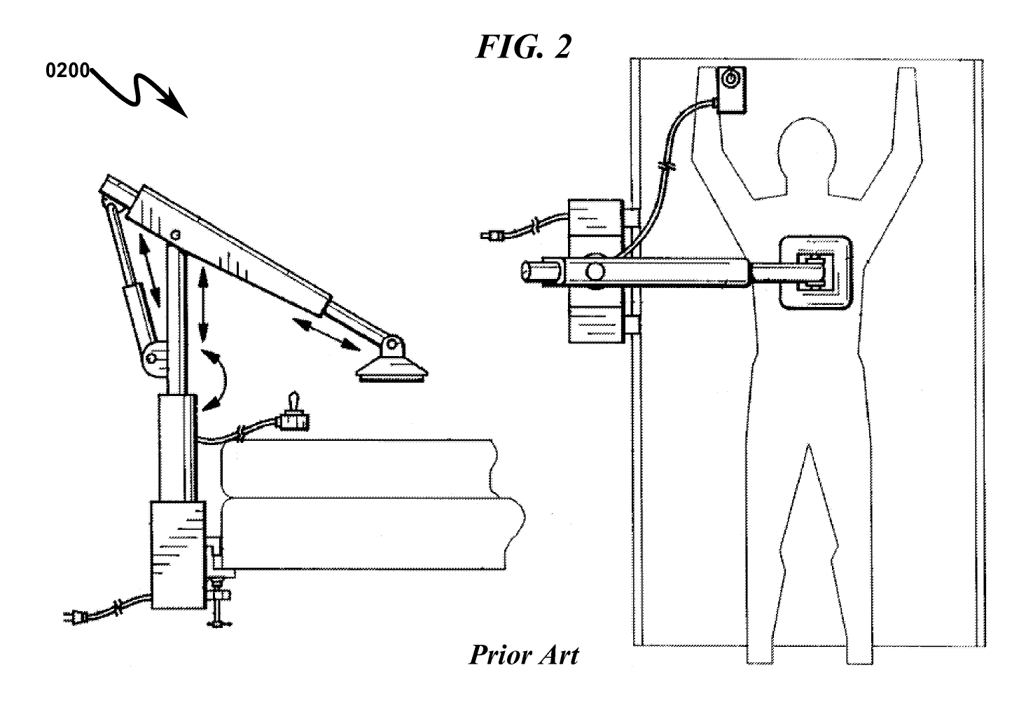

FIG. 3 illustrates a prior art massage table depicted in U.S. Pat. No. 5,022,386;

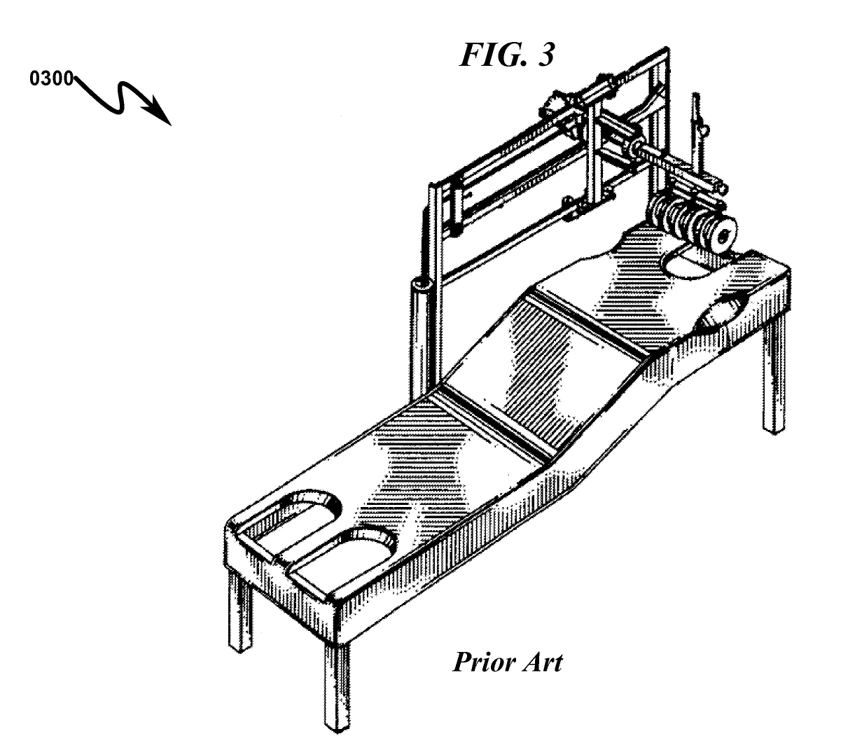

FIG. 4 illustrates an exemplary system block diagram depicting a preferred exemplary invention system embodiment;

FIG. 5 illustrates a side view of a simplified exemplary system embodiment construction overview depicting a first horizontal slide assembly position;

FIG. 6 illustrates a front right perspective view of a simplified exemplary system embodiment construction overview depicting a first horizontal slide assembly position;

FIG. 7 illustrates a side view of a simplified exemplary system embodiment construction overview depicting a second horizontal slide assembly position;

FIG. 8 illustrates a rear right perspective view of a simplified exemplary system embodiment construction overview depicting a second horizontal slide assembly position;

FIG. 9 illustrates a flowchart depicting a preferred exemplary invention method embodiment;

FIG. 10 illustrates a flowchart depicting a preferred exemplary invention method embodiment;

FIG. 11 illustrates a preferred exemplary system embodiment implementing computerized control for the CIB;

FIG. 12 illustrates a preferred exemplary system embodiment implementing interaction with a remote process control computer system for the purposes of downloading massage programs for the CIB;

FIG. 13 illustrates a flowchart depicting exemplary CIB control system functions useful in some preferred invention embodiments;

FIG. 14 illustrates the use of programmed patient massage profiles for the HCA and VCA;

FIG. 15 illustrates an exemplary pneumatic system schematic for a preferred invention embodiment with additional construction detail provided in FIG. 16-FIG. 64;

FIG. 16 illustrates an unannotated perspective right side view of a preferred exemplary invention embodiment with horizontal and vertical cylinders retracted;

FIG. 17 illustrates an annotated perspective right side view of a preferred exemplary invention embodiment with horizontal and vertical cylinders retracted;

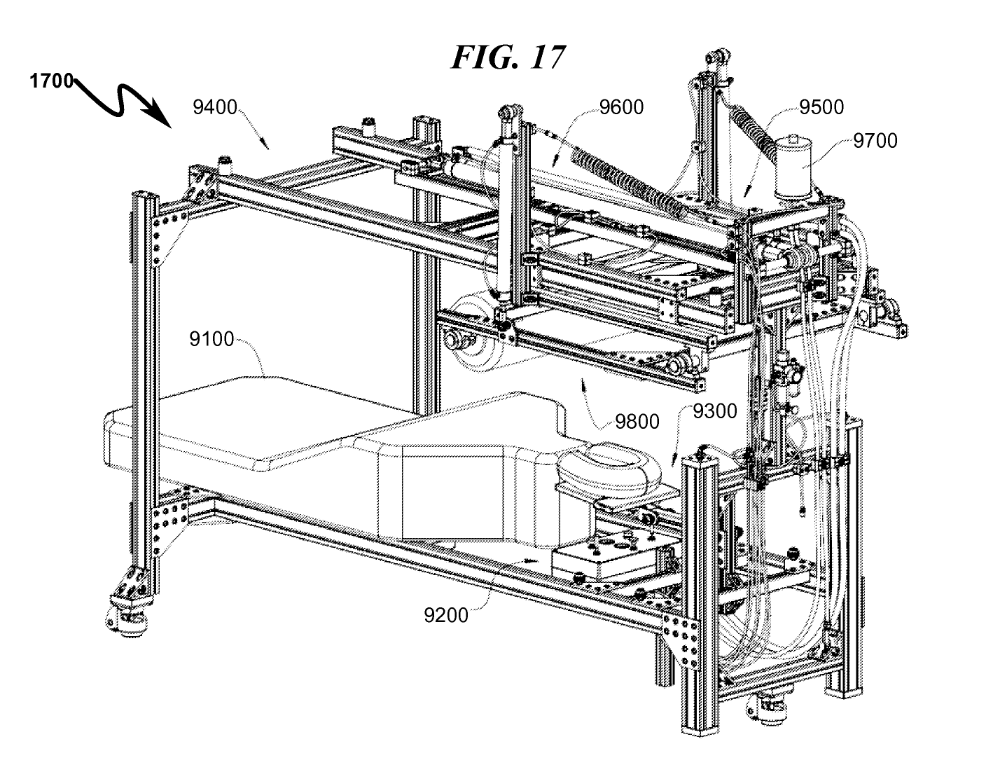

FIG. 18 illustrates an unannotated perspective left side view of a preferred exemplary invention embodiment with horizontal and vertical cylinders retracted;

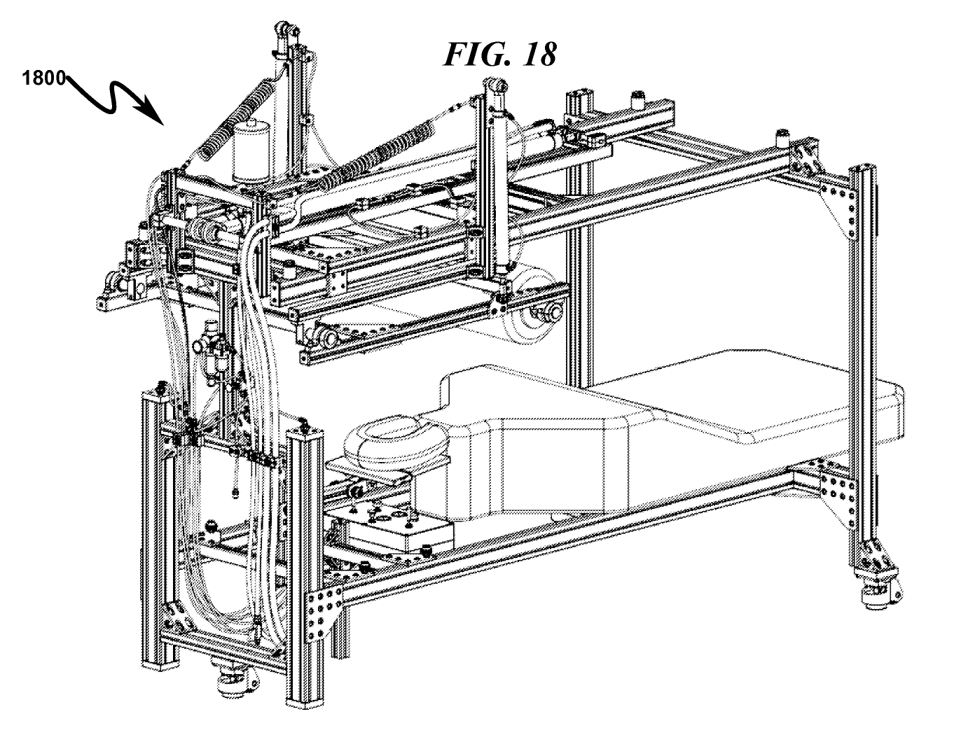

FIG. 19 illustrates an annotated perspective left side view of a preferred exemplary invention embodiment;

FIG. 20 illustrates an unannotated rear view of a preferred exemplary invention embodiment;

FIG. 21 illustrates an unannotated top view of a preferred exemplary invention embodiment;

FIG. 22 illustrates an unannotated right side view of a preferred exemplary invention embodiment;

FIG. 23 illustrates an annotated right side view of a preferred exemplary invention embodiment;

FIG. 24 illustrates right side perspective view of a preferred exemplary invention patient support table (PST) embodiment;

FIG. 25 illustrates perspective views of a preferred exemplary invention body contact assembly and vertical cylinder assembly embodiments;

FIG. 26 illustrates an unannotated perspective view of an exemplary horizontal cylinder assembly;

FIG. 27 illustrates an annotated perspective view of an exemplary horizontal cylinder assembly;

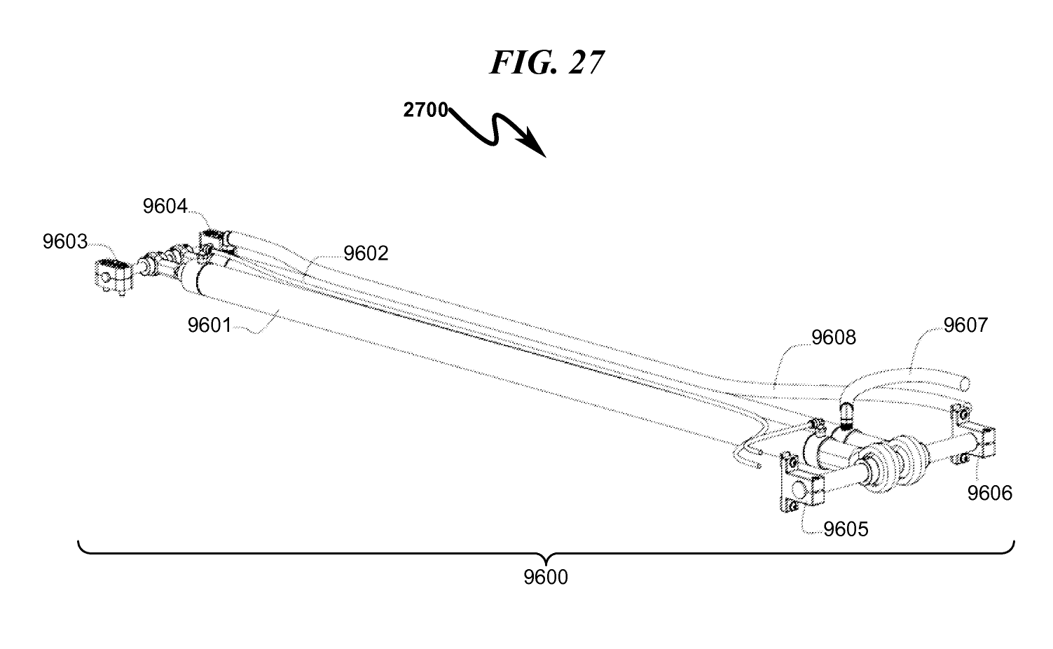

FIG. 28 illustrates an unannotated top view of an exemplary horizontal cylinder assembly;

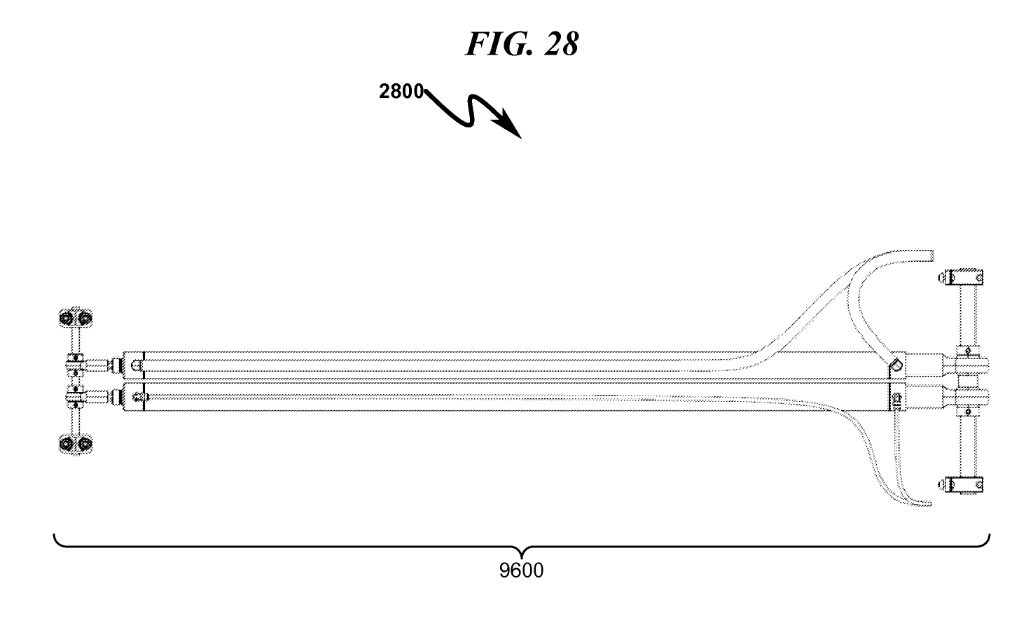

FIG. 29 illustrates an annotated top view of an exemplary horizontal cylinder assembly;

FIG. 30 illustrates an unannotated perspective view of an exemplary horizontal slide assembly;

FIG. 31 illustrates an annotated perspective view of an exemplary horizontal slide assembly;

FIG. 32 illustrates an unannotated perspective view of an exemplary horizontal slide assembly;

FIG. 33 illustrates an annotated perspective of an exemplary horizontal slide assembly;

FIG. 34 illustrates an unannotated back view of an exemplary horizontal slide assembly;

FIG. 35 illustrates an unannotated top view of an exemplary horizontal slide assembly;

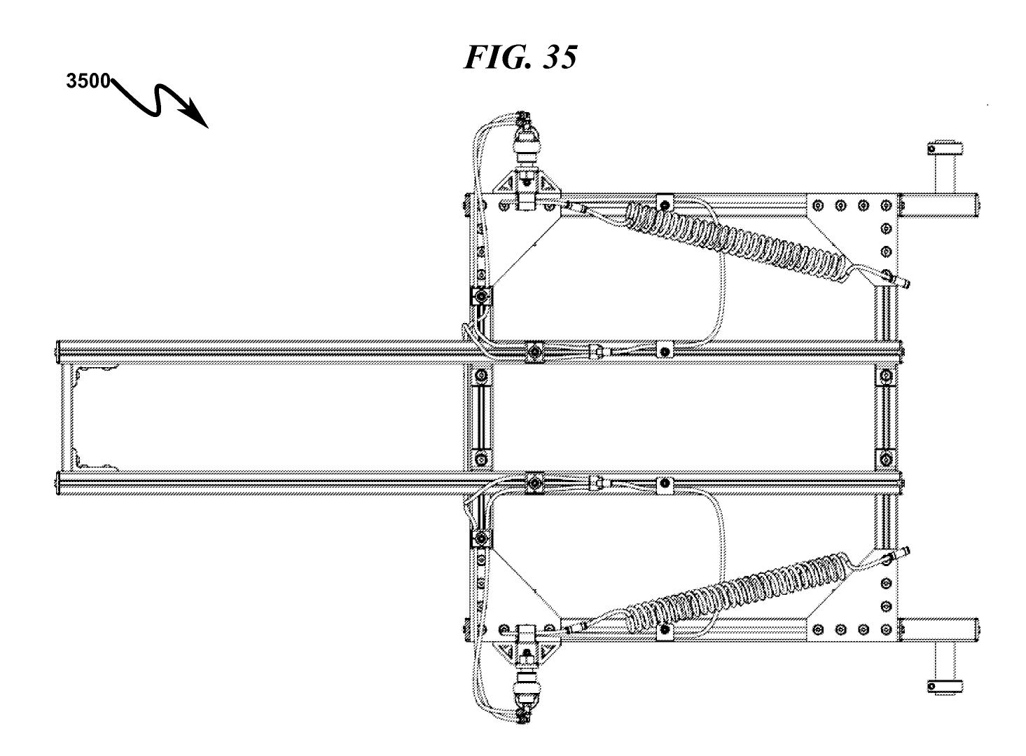

FIG. 36 illustrates an unannotated right side view of an exemplary horizontal slide assembly;

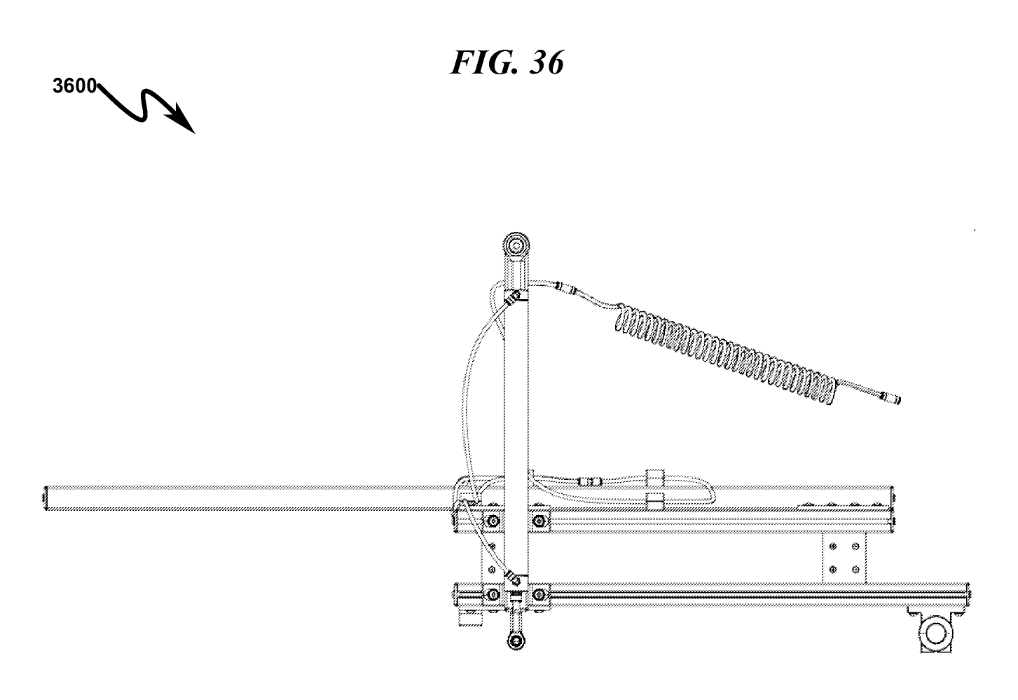

FIG. 37 illustrates an annotated right side view of an exemplary horizontal slide assembly;

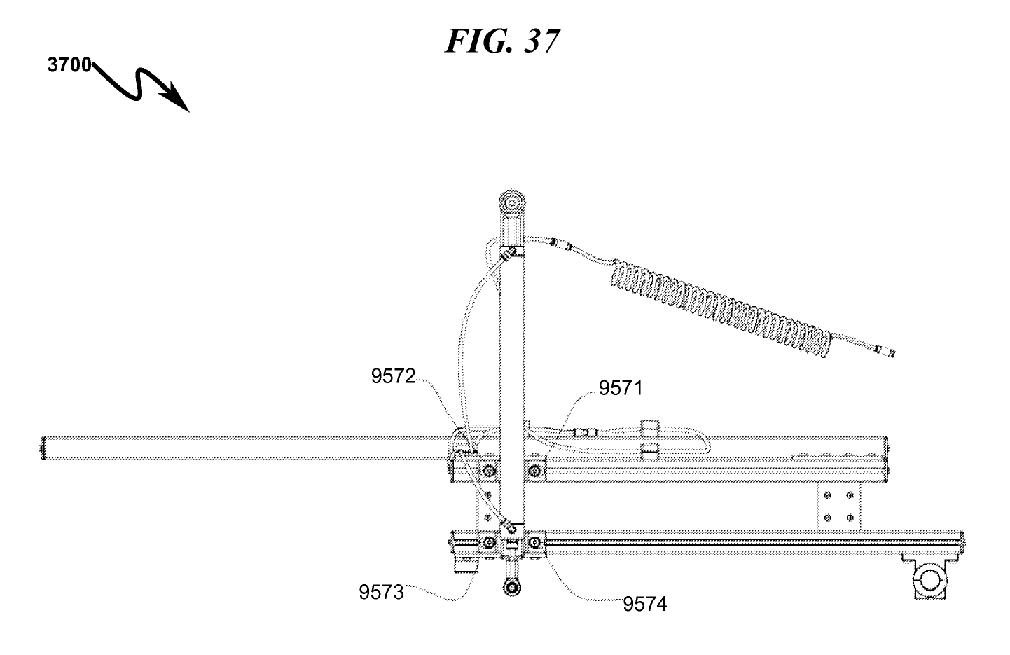

FIG. 38 illustrates an unannotated left side view of an exemplary horizontal slide assembly;

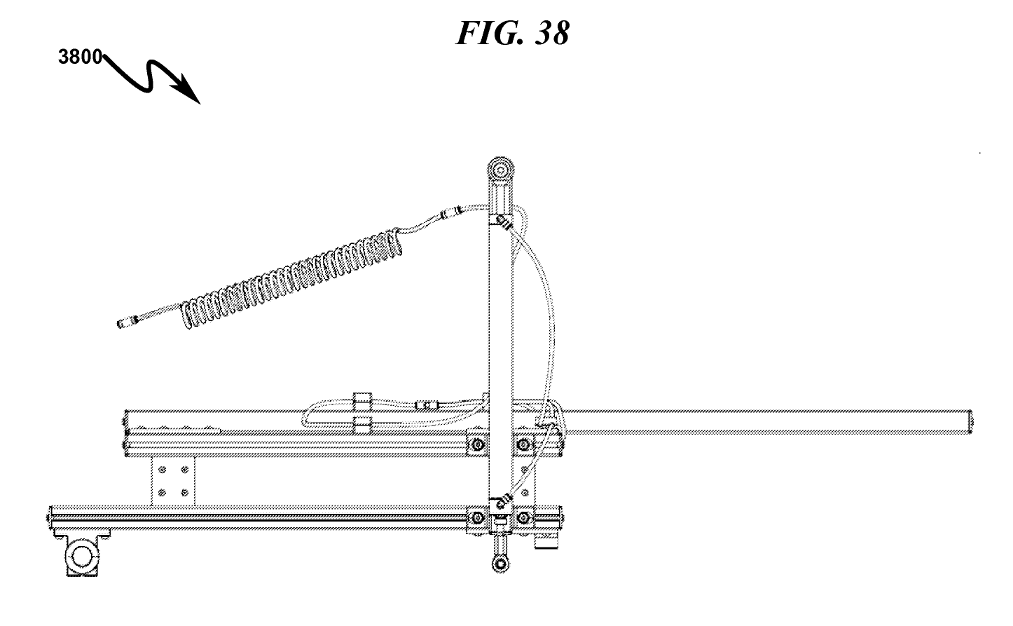

FIG. 39 illustrates an annotated left side view of an exemplary horizontal slide assembly;

FIG. 40 illustrates an unannotated perspective view of an exemplary body contact assembly;

FIG. 41 illustrates an annotated perspective view of an exemplary body contact assembly;

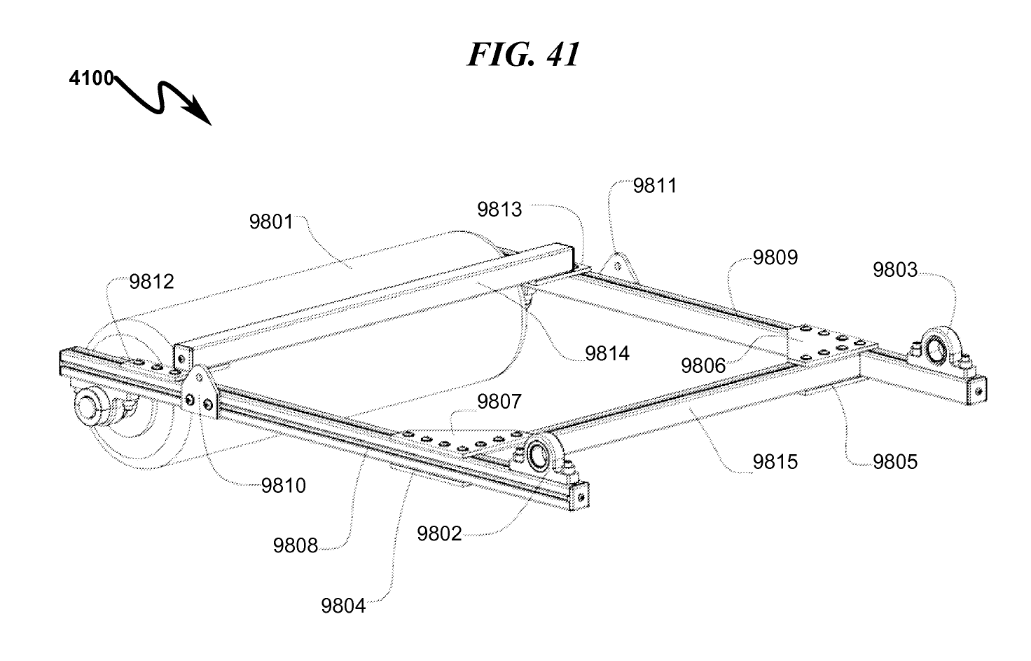

FIG. 42 illustrates an unannotated side view of an exemplary body contact assembly;

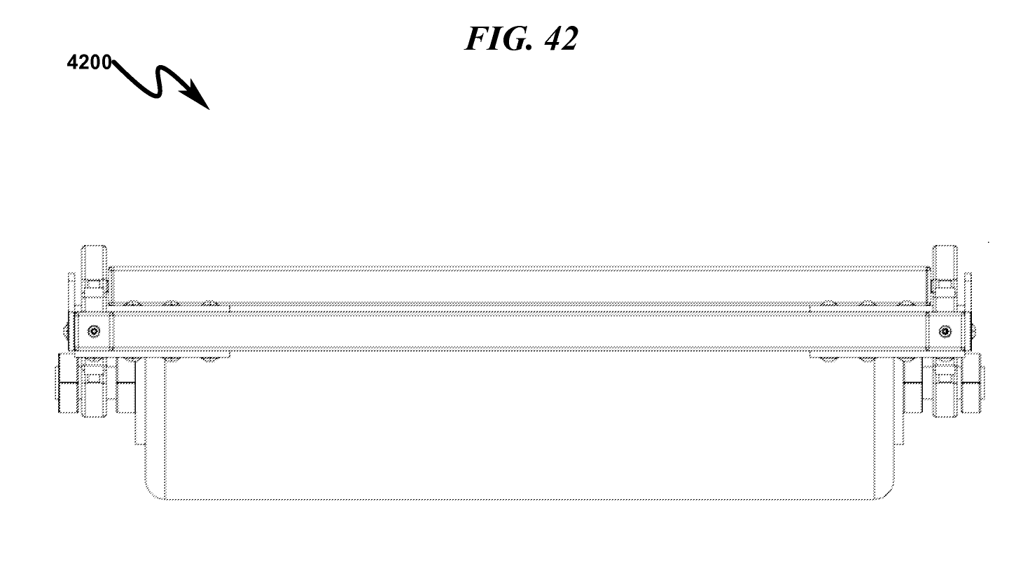

FIG. 43 illustrates an annotated side view of an exemplary body contact assembly;

FIG. 44 illustrates an unannotated side perspective view of an exemplary control interface box;

FIG. 45 illustrates an annotated side perspective view of an exemplary control interface box;

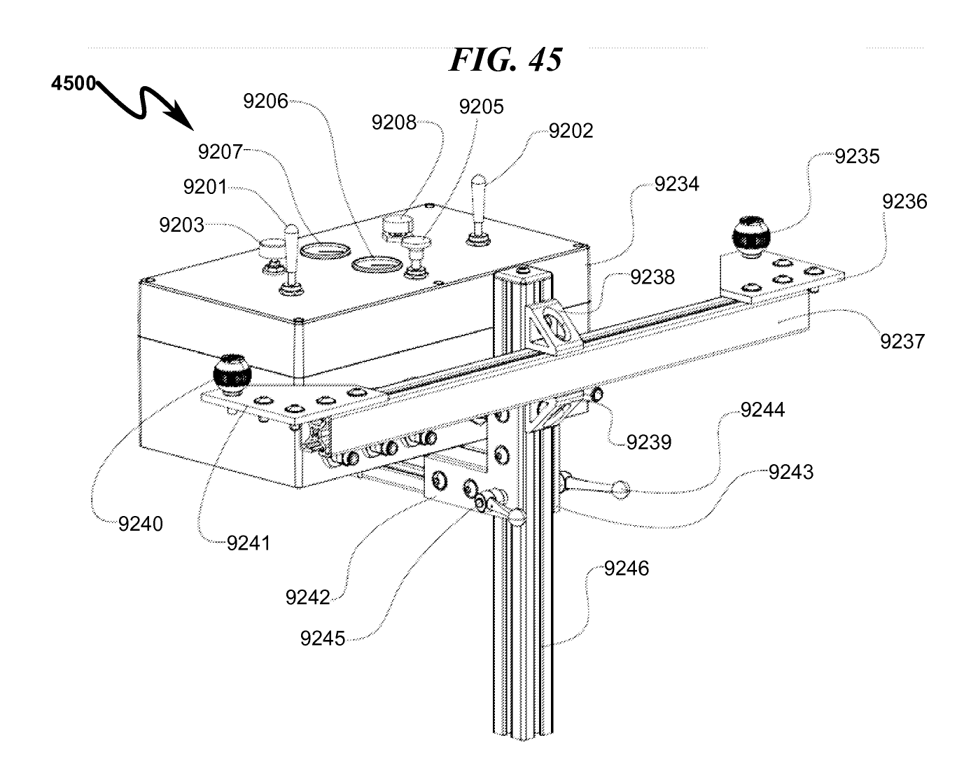

FIG. 46 illustrates an unannotated side view of an exemplary control interface box;

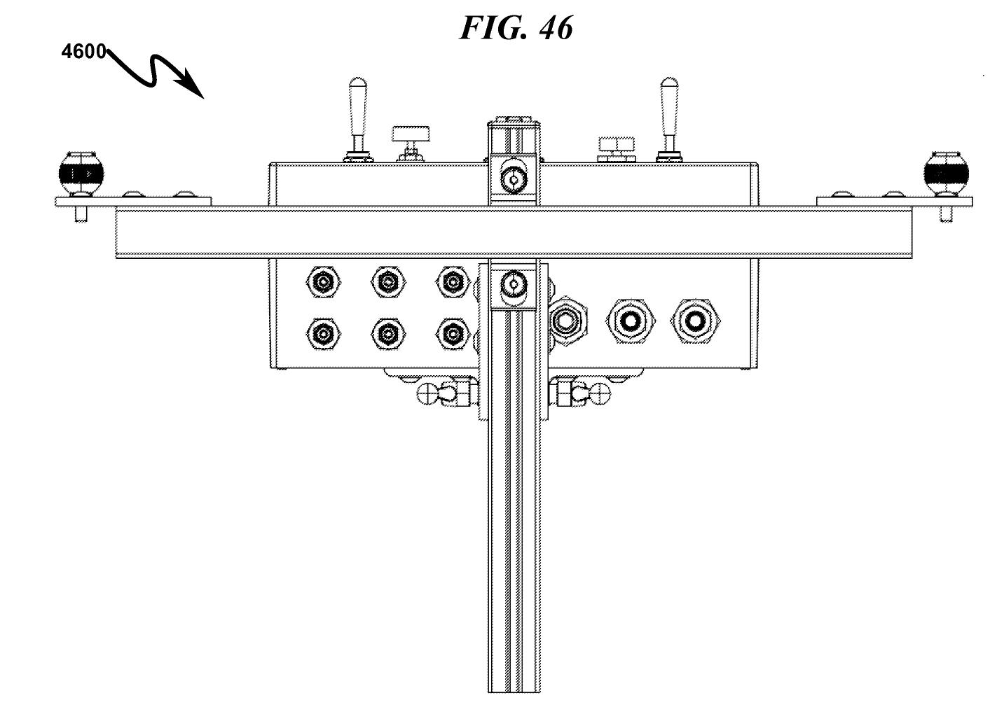

FIG. 47 illustrates an annotated side view of an exemplary control interface box;

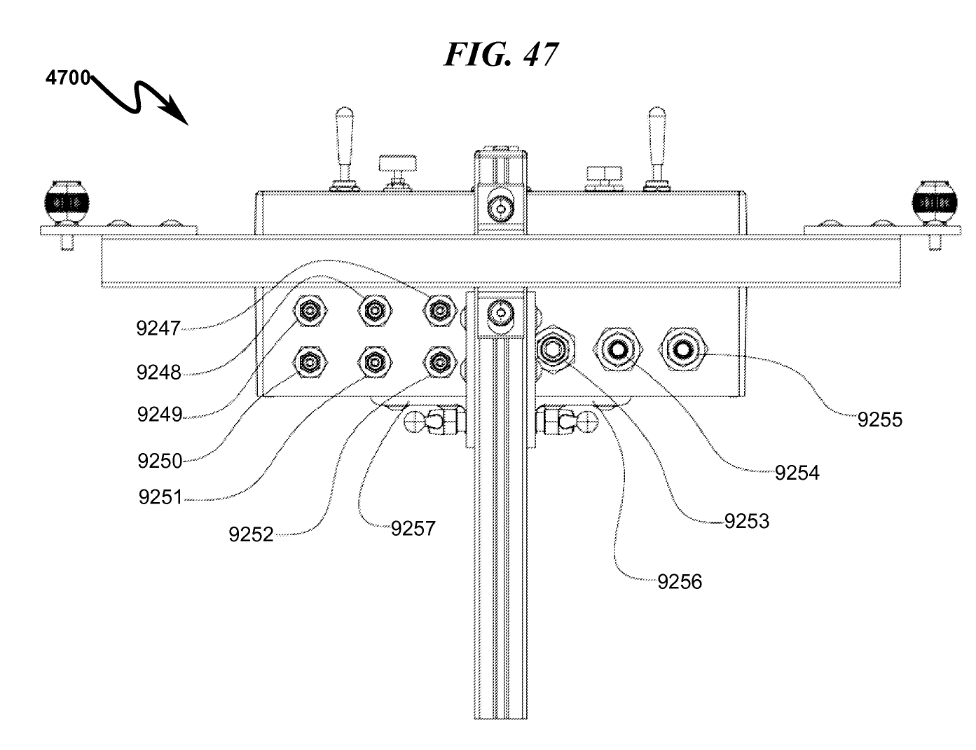

FIG. 48 illustrates an unannotated top perspective view of an exemplary control interface box;

FIG. 49 illustrates an unannotated right side perspective view of an exemplary patient face cradle;

FIG. 50 illustrates an annotated right side perspective view of an exemplary patient face cradle;

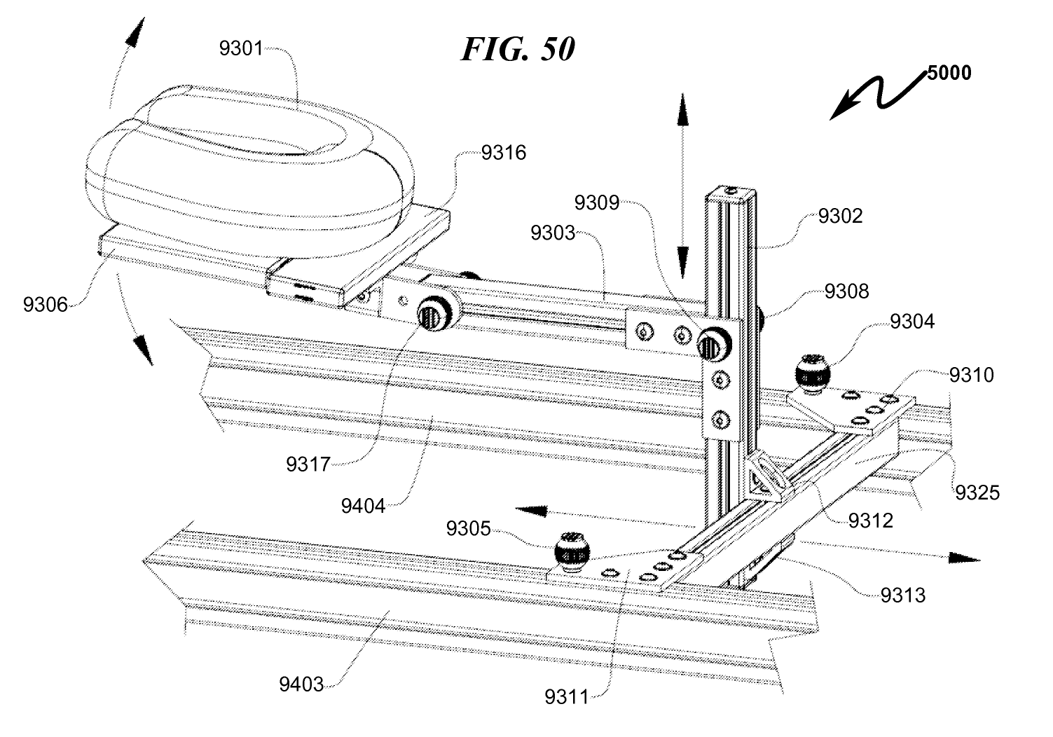

FIG. 51 illustrates a bottom unannotated view of an exemplary patient face cradle;

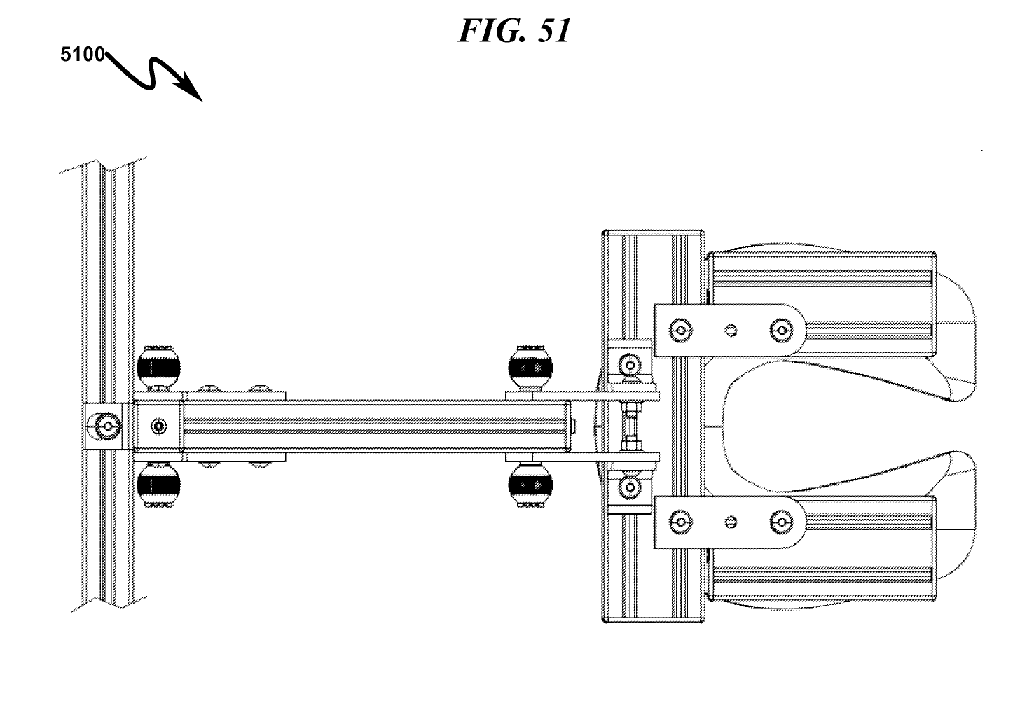

FIG. 52 illustrates a bottom annotated view of an exemplary patient face cradle;

FIG. 53 illustrates a right side perspective view of an exemplary frame support structure;

FIG. 54 illustrates a left side perspective view of an exemplary frame support structure;

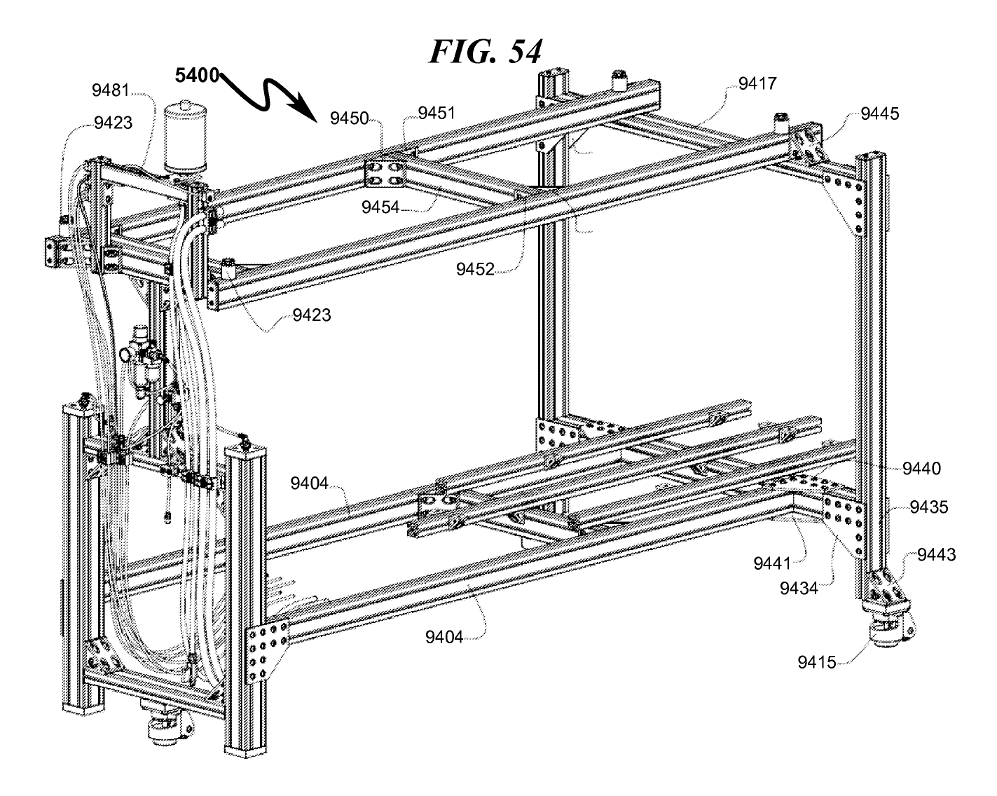

FIG. 55 illustrates a right rear perspective view of an exemplary frame support structure;

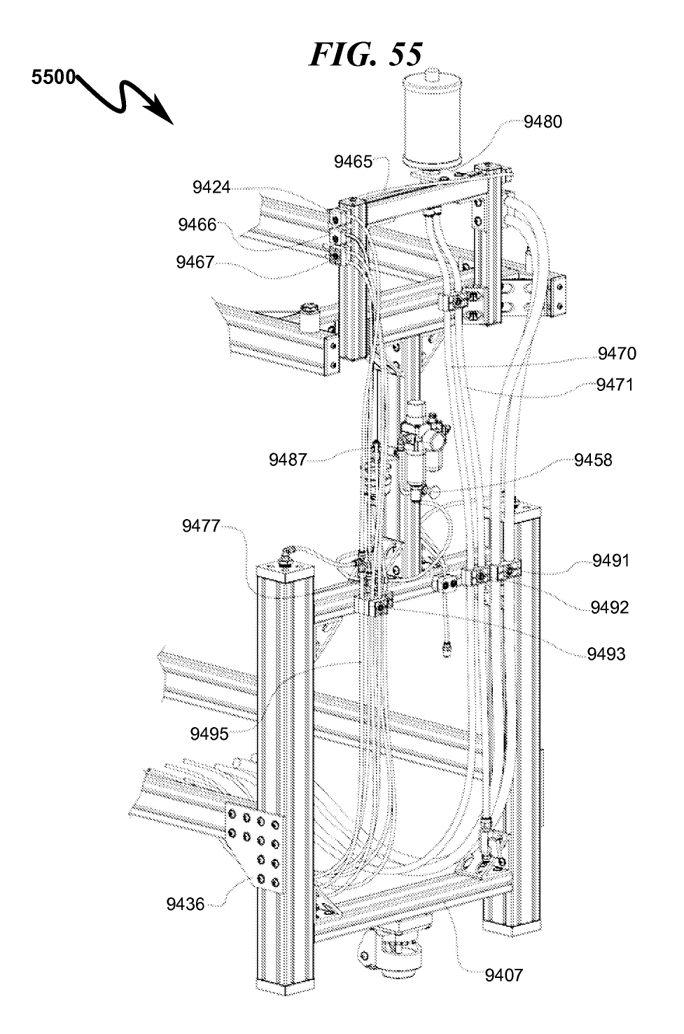

FIG. 56 illustrates a left rear perspective view of an exemplary frame support structure;

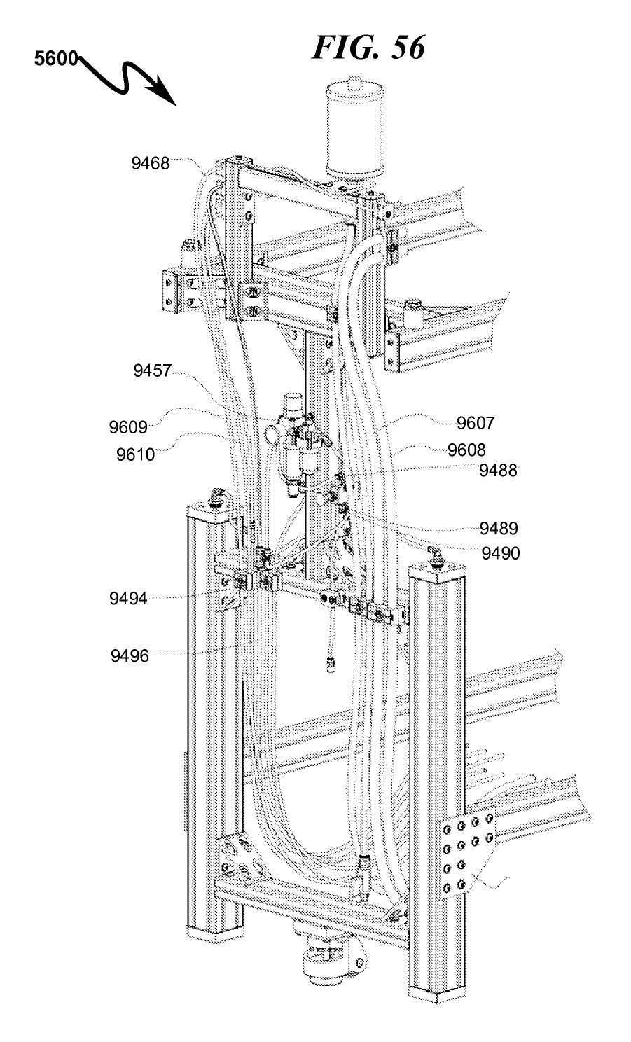

FIG. 57 illustrates a front detail view of an exemplary frame support structure;

FIG. 58 illustrates a right rear perspective view of a preferred exemplary embodiment with patient positioned and horizontal slide assembly extended approximately 36-inches with body contact assembly fully raised in the “UP” position;

FIG. 59 illustrates a right rear perspective view of a preferred exemplary embodiment with patient positioned and horizontal slide assembly extended approximately 36-inches with body contact assembly contacting the patient;

FIG. 60 illustrates a right rear perspective view of a preferred exemplary embodiment with patient positioned and horizontal slide assembly extended approximately 11-inches with body contact assembly contacting the patient;

FIG. 61 illustrates a right side view of a preferred exemplary embodiment with patient positioned depicting various possible positions of the body contact assembly;

FIG. 62 illustrates a right side view of a preferred exemplary embodiment with patient positioned and horizontal slide assembly partially extended approximately 11-inches with body contact assembly contacting the patient;

FIG. 63 illustrates a right side view of a preferred exemplary embodiment with patient positioned and horizontal slide assembly extended approximately 36-inches with body contact assembly contacting the patient; and

FIG. 64 illustrates a right side view of a preferred exemplary embodiment with patient positioned and horizontal slide assembly extended approximately 36-inches with body contact assembly fully raised.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a MASSAGE TABLE SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Prior Art Comparison

The massage functions provided by the present invention are not duplicated by the prior art in that no other massage device allows a user to self-apply compression and stretching therapy with integrated patient/therapist controls. The present invention consists of a table, adjustable control box with pneumatic circuitry and manual controls, adjustable face cradle assembly, frame, casters, slide assembly with vertical cylinders, horizontal cylinder assembly, liquid circuit, body contact assembly, and mechanical coupling brackets, conductors, fasteners, etc.

The present invention in a preferred system structure may be constructed mostly of slotted aluminum extrusions, which gives the machine the advantage of being easy to assemble, and adjustable to accommodate various sized patients. The slide assembly's plain bearings easily move along the anodized aluminum surface of the frame with little friction. The one-piece integrated structure makes it rigid, allowing deeper massage pressure without causing the sliding carriage to lift away from the table.

The patient mounts the machine and uses pneumatic controls to manipulate the body contact assembly, which pivots on one end of the slide assembly. Vertical cylinders lift and lower the roller mounted on the opposite end of the body contact assembly. Horizontal cylinders move the slide assembly and body contact assembly along the support frame rails. A damper cylinder circuit is used to control horizontal movement.

While the following description contains many details, these should not be construed as limitations on the invention scope. Many variations are possible, such as the use of a pad instead of a roller as the body contact means. The control box may be optionally mounted on the side of the machine for control by a therapist. Various pneumatic circuits are also possible to provide for variations in massage operation.

### System Overview (0400)

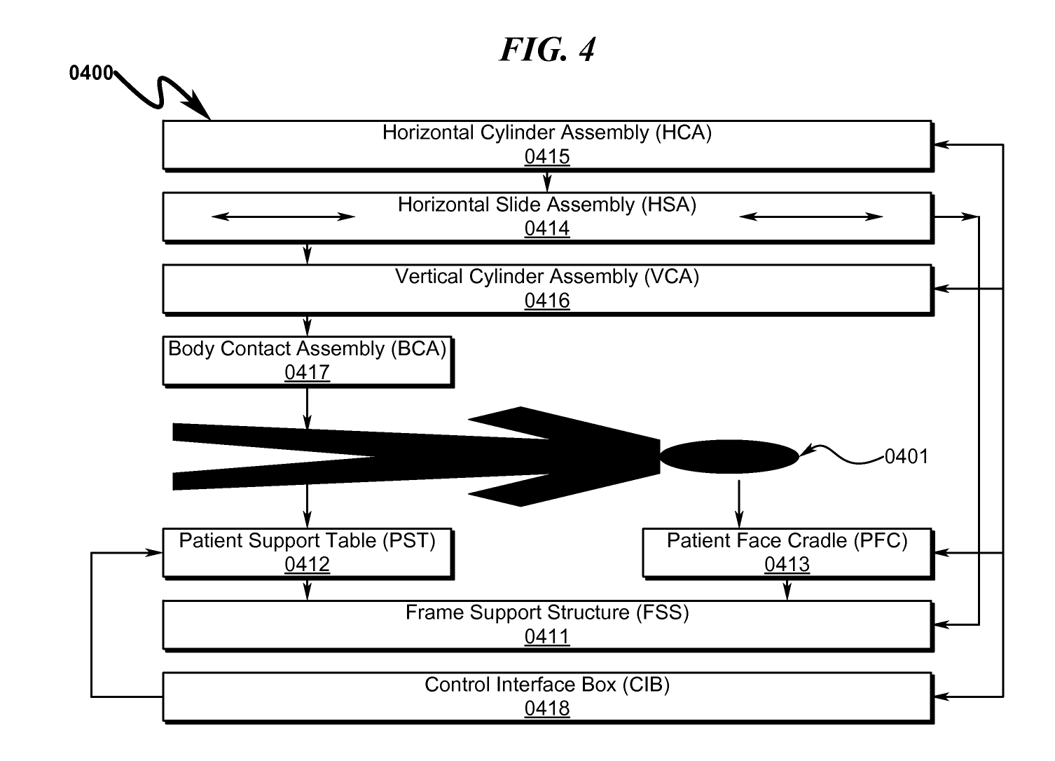

As generally illustrated in FIG. 4 (0400), a system block diagram of the present invention comprises a frame support structure (FSS) (0411) that supports a patient support table (PST) (0412) and patient face cradle (PFC) (0413) on which a patient (0401) is positioned face-down.

The frame support structure (FSS) (0411) also supports and is mechanically coupled to a horizontal slide assembly (HAS) (0414) that is configured to horizontally articulate over the patient (0401) by means of a horizontal cylinder assembly (HCA) (0415). The horizontal cylinder assembly (HCA) (0415) also supports a vertical cylinder assembly (VCA) (0416) that applies a body contact assembly (BCA) (0417) to the patient (0401) under pressure to support controlled massage of the patient. A control interface box (CIB) (0418) permits control of the HCA (0415) and VCA (0416) for the purposes of coordinating the patient massage and monitoring applied massage pressures, application speeds, and/or patient application points.

Within this context the patient (0401) lies face down on the massage table with face in an adjustable patient face cradle (PFC) (0413) and hands on the control interface box (CIB) (0418). The patient or therapist may control the horizontal movement of the body contact assembly (BCA) (0417) which may comprise a roller, pad, or similar massaging means. The horizontal speed of the body contact assembly (BCA) (0417) is determined by a pneumatic cylinder in the horizontal cylinder assembly (HCA) (0415) and modulated with a liquid damper cylinder to provide precise horizontal speed control of the massage process. The patient or therapist may also control the downward pressure of the body contact assembly (BCA) (0417) by adjusting a regulator or throttling a manual pneumatic valve.

Within this context the system may operate manually from controls present on the control interface box (CIB) (0418) or under control of a computer system executing machine instructions read from a computer readable medium operating in conjunction with the control interface box (CIB) (0418). Within the computer controlled context, a variety of “learning” modes may be programmed in which a patient/therapist defines a range/speed/pressure massage application therapy using the CIB (0418), and this information is stored by the computer system to permit repeated application of the massage therapy to the patient. These stored therapy programs may then be applied to specific patients or generalized with parameters entered into the user interface of the CIB (0418) to permit modification of preprogrammed massage therapy parameters for use by a specific patient.

### Simplified System Configuration (0500)-(0800)

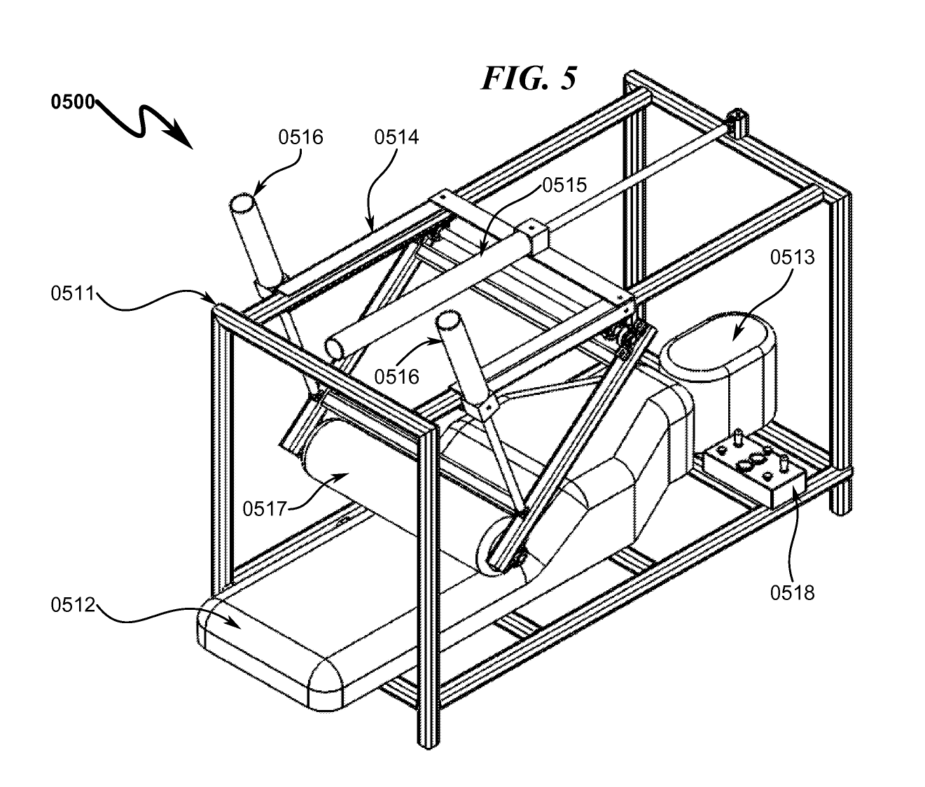

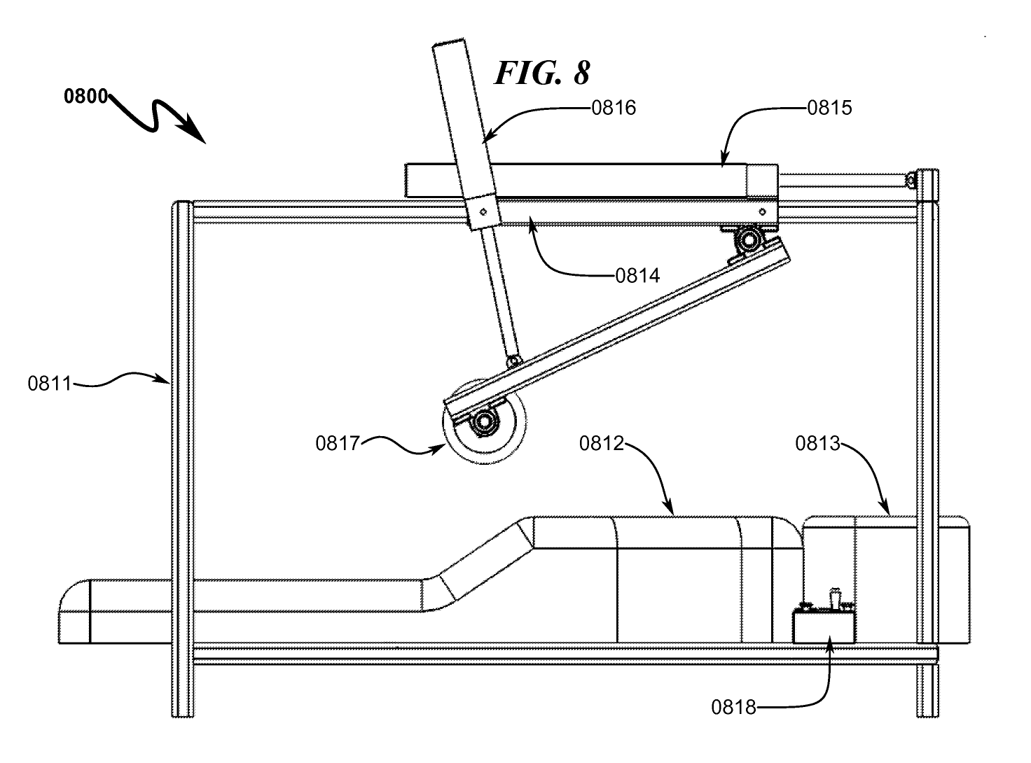

As an aid in understanding the present invention, simplified exemplary system embodiment configuration views are presented in FIG. 5 (0500)-FIG. 8 (0800). Referencing FIG. 5 (0500)-FIG. 8 (0800), the simplified system views illustrate the frame support structure (FSS) (0511, 0611, 0711, 0811) that supports the patient support table (PST) (0512, 0612, 0712, 0812) and patient face cradle (0513, 0613, 0713, 0813). The horizontal slide assembly (HSA) (0514, 0614, 0714, 0814) slides along the length of the FSS (0511, 0611, 0711, 0811) and is positioned horizontally by use of the horizontal cylinder assembly (HCA) (0515, 0615, 0715, 0815). The HSA (0514, 0614, 0714, 0814) also supports the vertical cylinder assembly (VCA) (0516, 0616, 0716, 0816) that vertically articulates the body contact assembly (BCA) (0517, 0617, 0717, 0817) that makes contact with the patient. The HCA (0515, 0615, 0715, 0815) and VCA (0516, 0616, 0716, 0816) are controlled pneumatically via the use of a control interface box (CIB) (0518, 0618, 0718, 0818) that may be mounted and/or adjusted for operation by a patient and/or massage therapist.

As shown in FIG. 5 (0500)-FIG. 8 (0800), the HCA (0515, 0615, 0715, 0815) is depicted as incorporating a single pneumatic cylinder and the VCA (0516, 0616, 0716, 0816) is depicted as incorporating two pneumatic cylinders. This is illustrative of the general concept that the HCA (0515, 0615, 0715, 0815) and the VCA (0516, 0616, 0716, 0816) may utilize any number (one or more) of pneumatic cylinders to implement their function without departing from the spirit of the claimed invention.

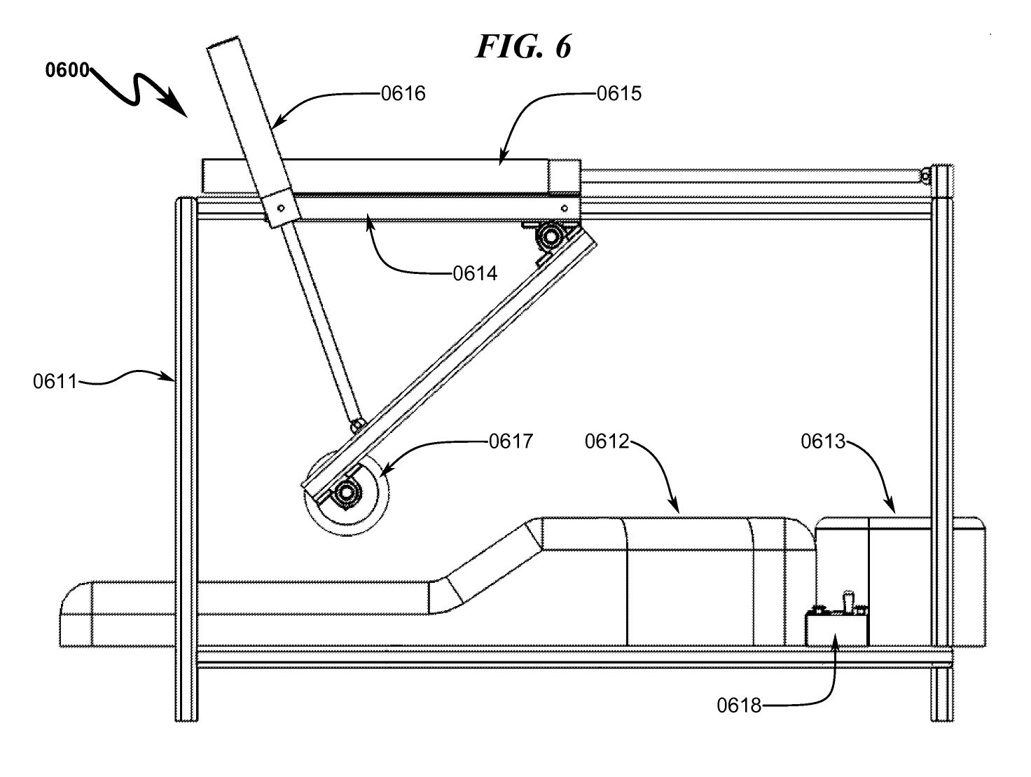

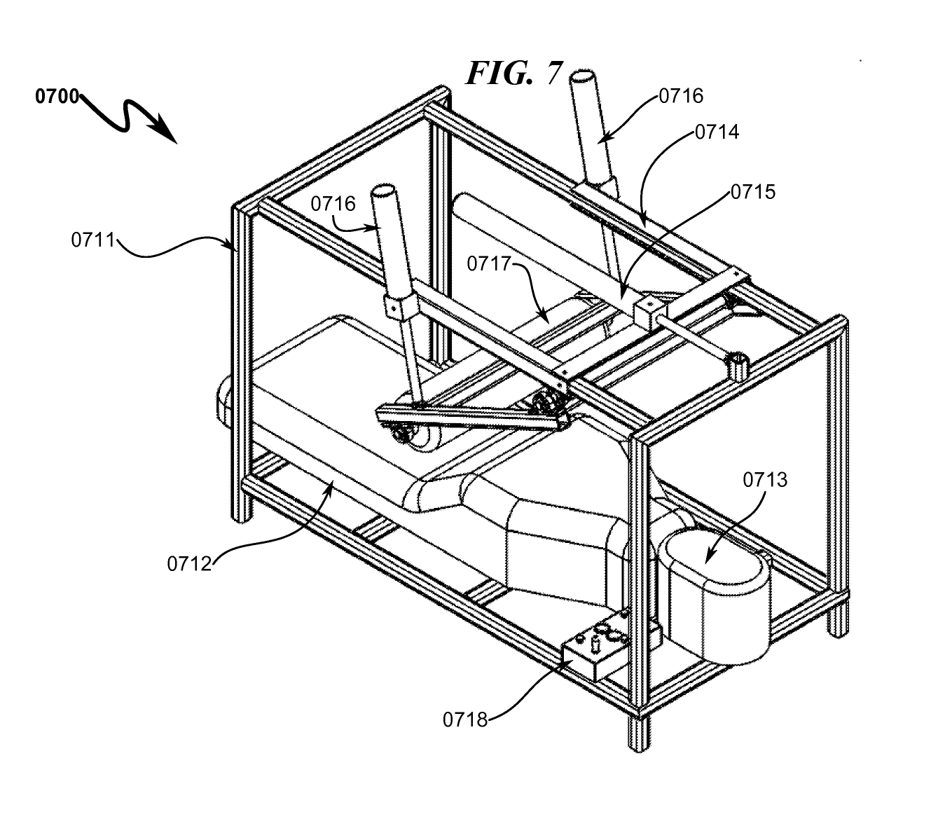

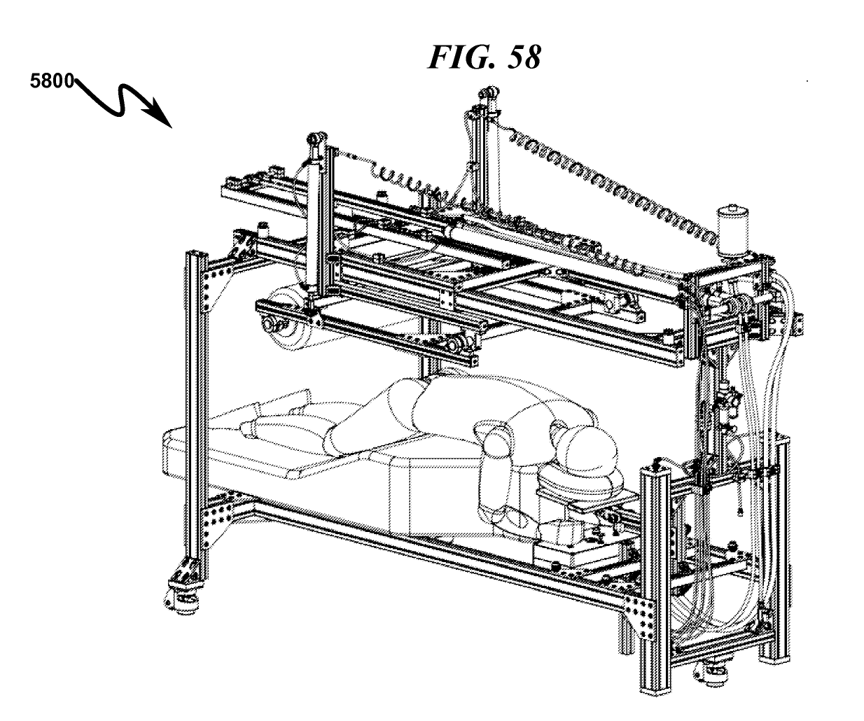

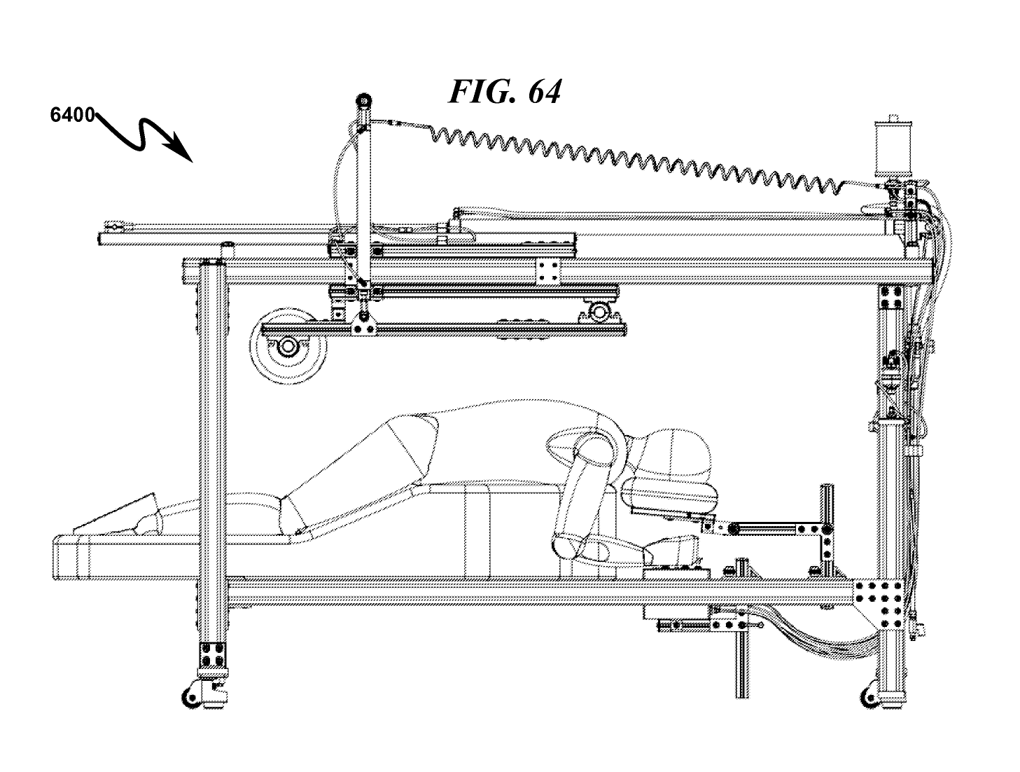

The views depicted in FIGS. 5-6 (0500, 0600) and FIGS. 7-8 (0700, 0800) respectively illustrate how the horizontal slide assembly (HSA) (0514, 0614, 0714, 0814) slides along the length of the FSS (0511, 0611, 0711, 0811) and also how the VCA (0516, 0616, 0716, 0816) may be used to position the body contact assembly (BCA) (0517, 0617, 0717, 0817) over the body of the patient. Additional examples of an exemplary system embodiment application context are provided in FIG. 58 (5800)-FIG. 64 (6400).

### Method Overview (0900)-(1000)

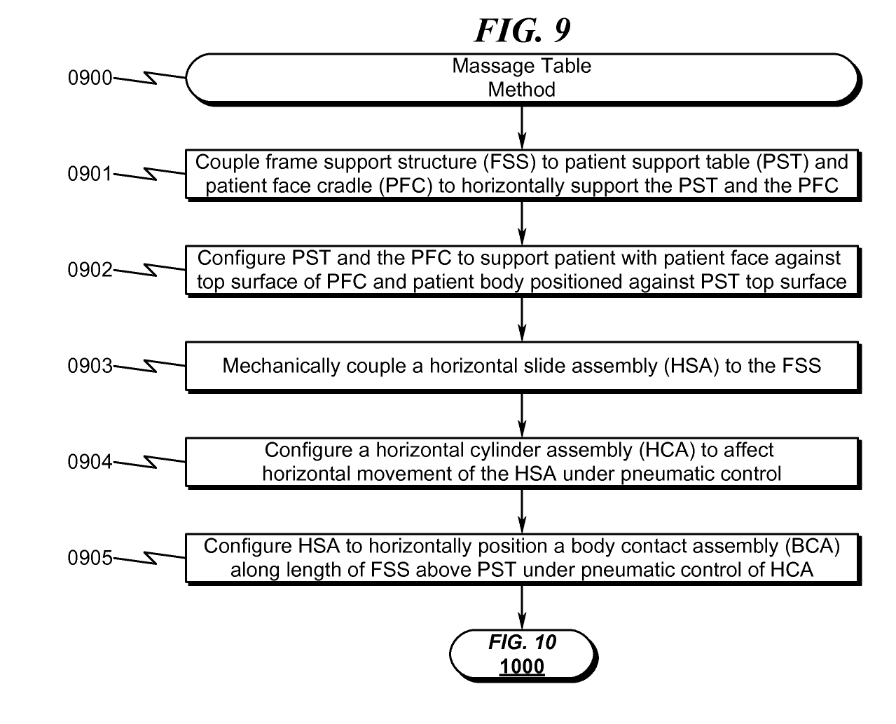

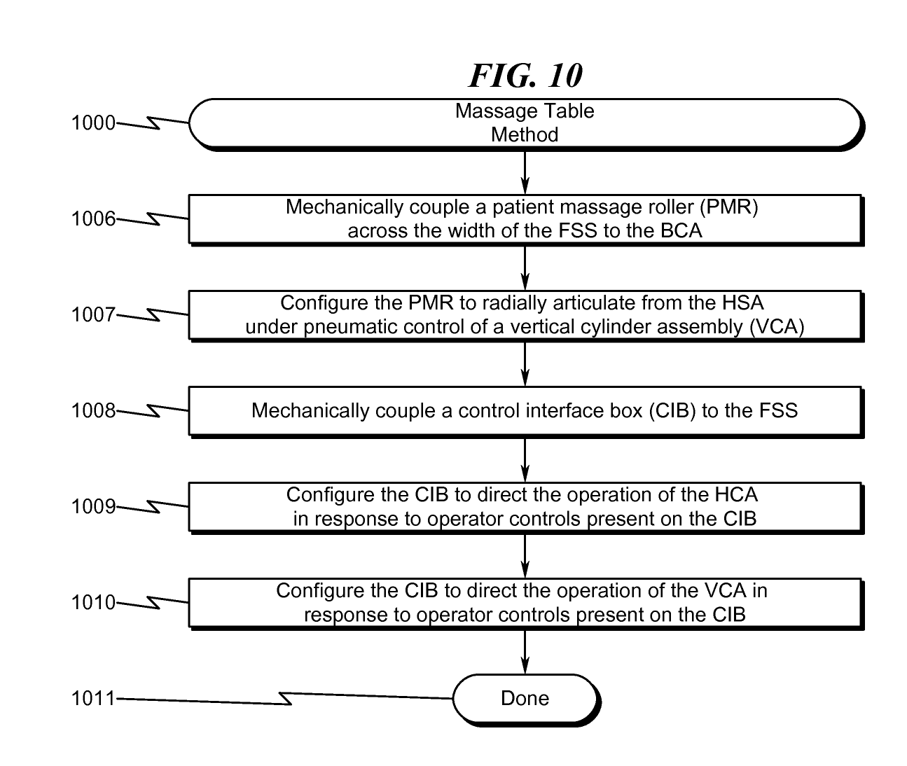

An exemplary present invention method can be generally described in the flowcharts of FIG. 9 (0900) and FIG. 10 (1000) as incorporating the following steps:
(1) mechanically coupling a frame support structure (FSS) to a patient support table (PST) and a patient face cradle (PFC) to horizontally support the PST and the PFC (0901);
(2) configuring the PST and the PFC to support a patient with the face of the patient positioned against the top surface of the PFC and the frontal body of the patient positioned against the top surface of the PST (0902);
(3) mechanically coupling a horizontal slide assembly (HSA) to the FSS (0903);
(4) configuring a horizontal cylinder assembly (HCA) to affect horizontal movement of the HSA under pneumatic control (0904);
(5) configuring the HSA to horizontally position a body contact assembly (BCA) along the length of the FSS above the PST under pneumatic control of the HCA (0905);
(6) mechanically coupling a patient massage roller (PMR) across the width of the FSS to the BCA (1006);
(7) configuring the PMR to radially articulate from the HSA under pneumatic control of a vertical cylinder assembly (VCA) (1007);
(8) mechanically coupling a control interface box (CIB) to the FSS (1008);
(9) configuring the CIB to direct the operation of the HCA in response to operator controls present on the CIB (1009); and
(10) configuring the CIB to direct the operation of the VCA in response to operator controls present on the CIB (1010);

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

This general method summary may be augmented by the various elements described herein to produce a wide variety of invention embodiments consistent with this overall design description. This method may incorporate computerized control within the CIB to affect execution of pre-programmed massage therapies as well as modes in which massage therapies manually directed by a patient or therapist are stored for later application to the patient as single-event massage therapies or repeated massage therapies.

### CIB Computerized Control System (1100)

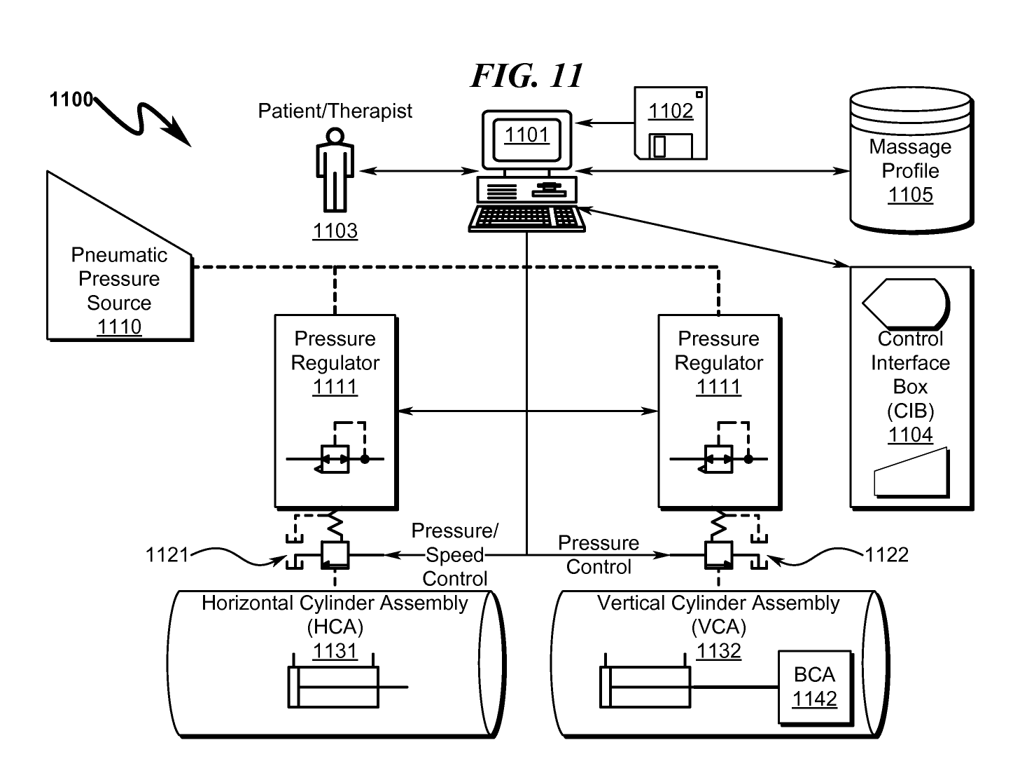

Some preferred invention embodiments may employ a computerized control system to automate the massage therapy controls as generally depicted in FIG. 11 (1100). In the preferred exemplary computerized embodiment illustrated in FIG. 11 (1100), a computer system (1101) executing instructions read from a computer readable medium (1102) interfaces with a patient and/or therapist (1103) via the use of the control interface box (CIB) (1104) user interface which may incorporate displays and/or keyboard inputs. The computer system maintains database (1105) of massage profiles which may be parameterized for use with a variety of patients or which may be stored massage program profiles that are applied to a specific patient. This massage profile database (1105) is then used to modulate a pneumatic pressure source (1110) (such as an air compressor) via use of pressure regulators (1111, 1112 that are then gated with electrically actuated valves (1121, 1122) that serve to modulate the pressure/speed of the horizontal cylinder assembly (HCA) (1131) and the pressure of the vertical cylinder assembly (VCA) (1132) that serve to coordinate the massage treatment for the patient.

This computerized control system presents a variety of massage treatment options for the patient and/or therapist that may be used to optimize patent massage treatment, including but not limited to the following:
Computer control of the HCA (1131) pneumatics and flow rate permits the position of the BCA (1142) to be accurately positioned over the patient for localization of the massage therapy.
Computer control of the HCA (1131) pneumatic flow rate permits the speed of the BCA (1142) as it traverses over the patient to be accurately controlled.
Computer control of the VCA (1132) pneumatic pressure permits the applied massage pressure to the patient to be accurately controlled as the BCA (1142) is positioned over the various body parts of the patient.
Computer control of the VCA (1132) pneumatic pressure permits the applied massage pressure to the patient to be varied as the BCA (1142) is positioned over the various body parts of the patient. This can result in a varying massage pressure profile that may vary based on the direction of BCA (1142) travel. This behavior is consistent with what might occur in a manual massage therapy session, but is more accurately repeatable using this computer control system and avoids the fatigue often present when massage is performed by a massage therapist.
Computer monitoring of the position, pressures, and timing associated with manual operation of the CIB (1104) permits this information to be stored as a customized repeatable massage profile (1105) that can be recalled and replayed for a particular patient or generic class of patient treatment. This “learning” mode allows the patient and/or therapist to define a set of HCA/VCA massage profiles and then repeat this stored profile a predefined number of times for repeated patient massage therapy.
Computer control of the position, pressures, and timing associated with automated operation of the HCA (1131) and VCA (1132) permits predefined massage therapy programs to be defined that are based on parameterized inputs associated with a particular patient. For example, a massage therapy program might first ask the patient height, weight, age, sex, and then determine for leg massage a particular HCA reciprocating massage profile is warranted to prevent blood clots in the legs of the patient. This information would then be used to position the HCA (1131) over the legs of the patient (based on the patient height) and then apply rolling massage pressure to the legs of the patient by activation of the VCA (1132) as applied to the BCA (1142). Repeated cycling of the HCA (1131) and contoured pressure profiles applied to the VCA (1132) may then be initiated by the computer control system to affect patient massage in this specific area. Similar parameterized programs may be created for back, neck, and other specific patient areas of treatment.
   One skilled in the art will recognize that this list is non-exhaustive and that some features may be combined in some preferred embodiments.

### Remote CIB Process Control (1200)

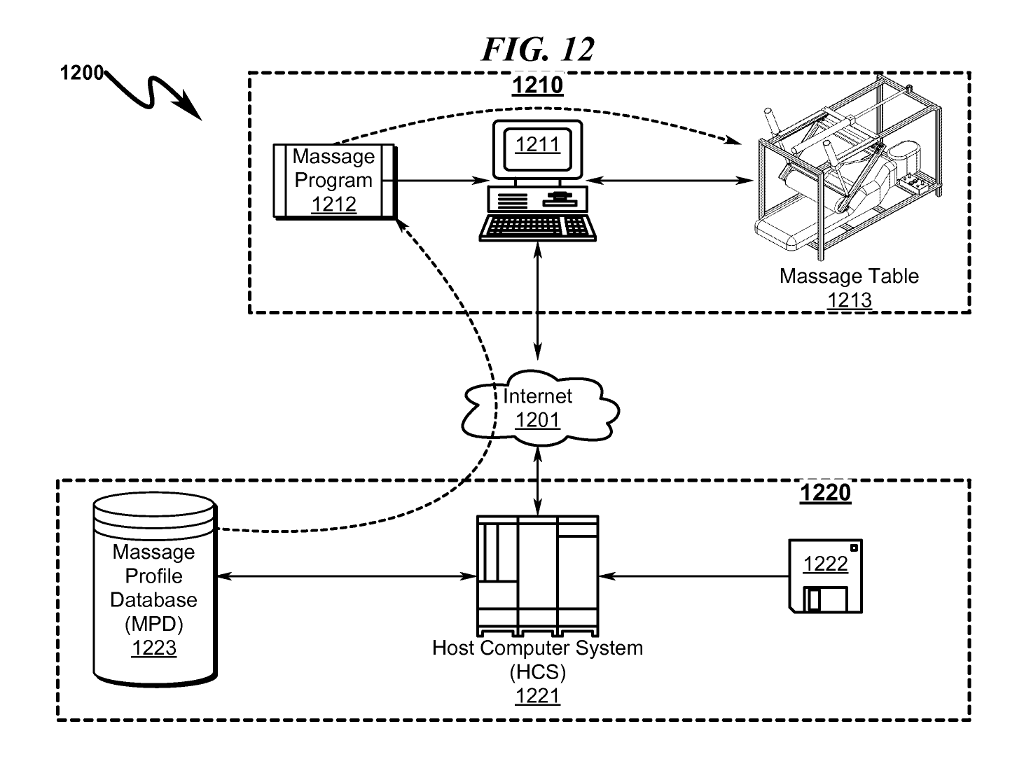

As generally depicted in FIG. 12 (1200), the present invention as configured in a system embodiment (1210) may be configured to communicate with a remote process control system (1220) (using a host computer system (1221)) via the Internet (or other computer communication network) (1201). In this configuration, the CIB control computer (1211) may be configured to execute a massage program (1212) that operates the pneumatic controls of the massage table (1213). Various massage profiles as executed by the massage program (1212) may be stored in a remote database (1223) and provided to the CIB computer (1211) via the use of software executed on the host computer system (1221) and retrieved from a computer readable medium (1222). This software may incorporate a web interface to permit downloading massage profiles for execution on the massage table (1213) via the use of a standard web browser interface on the HCS (1221).

As previously discussed, the CIB as incorporating computer controls may operate the massage table VCA and HCA under pneumatic control via valves that are electrically actuated under manual and/or computer control. This permits a wide variety of learned and/or pre-programmed massage programs to be executed in the context of the CIB control computer to affect a wide variety of therapeutic massage treatments.

### Exemplary CIB Control Method (1300)

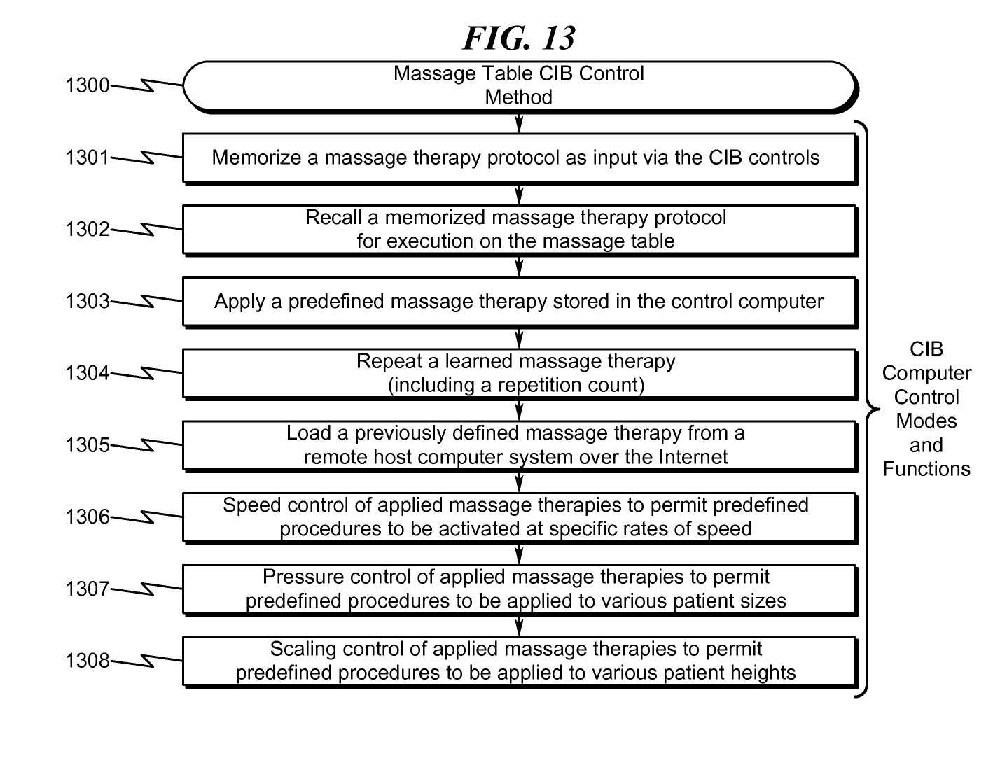

In circumstances where the CIB is computer controlled as depicted in FIG. 11 (1100) and FIG. 12 (1200), a variety of control methods may be used within the computer controls to affect a variety of operating modes for the massage system. These may include interaction with a graphical display, a web browser over the Internet, or in some cases simplified user interfaces comprising pushbuttons, joysticks, indicators, and other patient I/O devices. The method used within the computer controls to support these functions may vary widely, but an exemplary present invention CIB control method can be generally described in the flowchart of FIG. 13 (1300) as incorporating the following mode and function control steps:
(1) Providing for the memorization of a massage therapy protocol as input via the CIB controls (1301);
(2) Providing for the recall of a memorized massage therapy protocol for execution on the massage table (1302);
(3) Providing for the application of a predefined massage therapy that is stored in the control computer (such as in the case of specific therapies for portions of the patient body) (1303);
(4) Providing for repetition of a learned massage therapy (including a repetition count) (1304);
(5) Providing for loading of a previously defined massage therapy from a remote host computer system over the Internet (1305);
(6) Providing for speed control of applied massage therapies to permit predefined procedures to be activated at specific rates of speed (1306);
(7) Providing for pressure control of applied massage therapies to permit predefined procedures to be applied to various patient sizes (1307); and
(8) Providing for scaling control of applied massage therapies to permit predefined procedures to be applied to various patient heights (1308).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Parameterized Massage Profiles (1400)

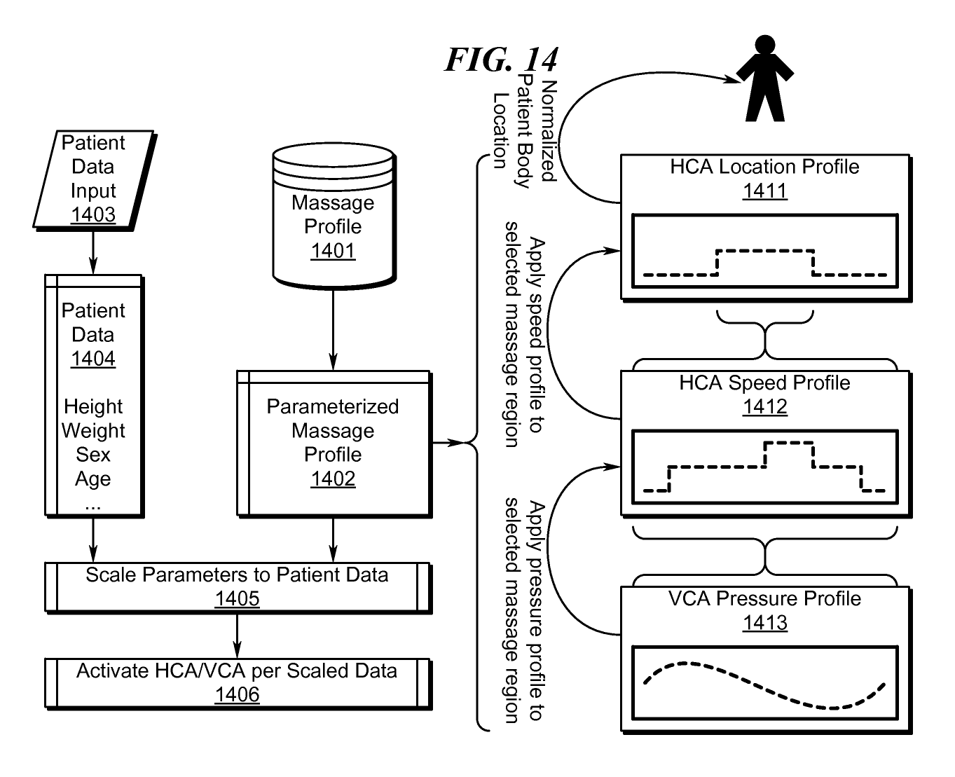

As indicated previously, computerized monitoring and control of the pneumatics within some preferred invention embodiments may permit parameterized massage profiles to be developed to enable a generalized massage therapy profile to be tailored to a specific patient based on their personal physical characteristics. An example of this is generally illustrated in FIG. 14 (1400), where a massage profile database (1401) comprises parameterized massage profile records (1402). These parameterized massage profile records (1402) in this example comprise HCA location profile records (1411) that describe which portion of the patient's body is to be massaged, HCA speed profile records (1412) that describe the speed at which the HCA is to traverse over the selected patient body region, and VCA pressure profile records (1413) that describe the pressure to be applied to the patient's massaged locations during the procedure.

These massage profile records (1411, 1412, 1413) are parameterized so that they may be scaled based on a particular patient's height, weight, sex, age, and other factors that are input (1403) to a patient dataset (1404). Scaling (1405) of the parameterized massage profile (1402) applies the patient information (1404) to these normalized datasets (1411, 1412, 1413) and produces scaled data (1405) that is then used to activate the HCA and VCA (1406) in a coordinated fashion to affect the massage therapy on the patient.

In this example the patient HCA location profile might indicate which horizontal portion of the normalized patient body is to be massaged by indicating a range of [0 . . . 1], with 0 being the bottom of the patient's feet and 1 being the top of the patient's head. Thus, a normalized location range of [0.25 . . . 0.50] would generally indicate from the patient's knees to their waist. This, when scaled by the patient's height data, would result in proper identification of these areas on an individual patient.

The present invention anticipates that various parameterized massage profiles (1402) may be created to target massage to a patient's neck, shoulders, upper back, lower back, hamstring, quadriceps, and calf muscles.

### Exemplary Pneumatic Schematic (1500)

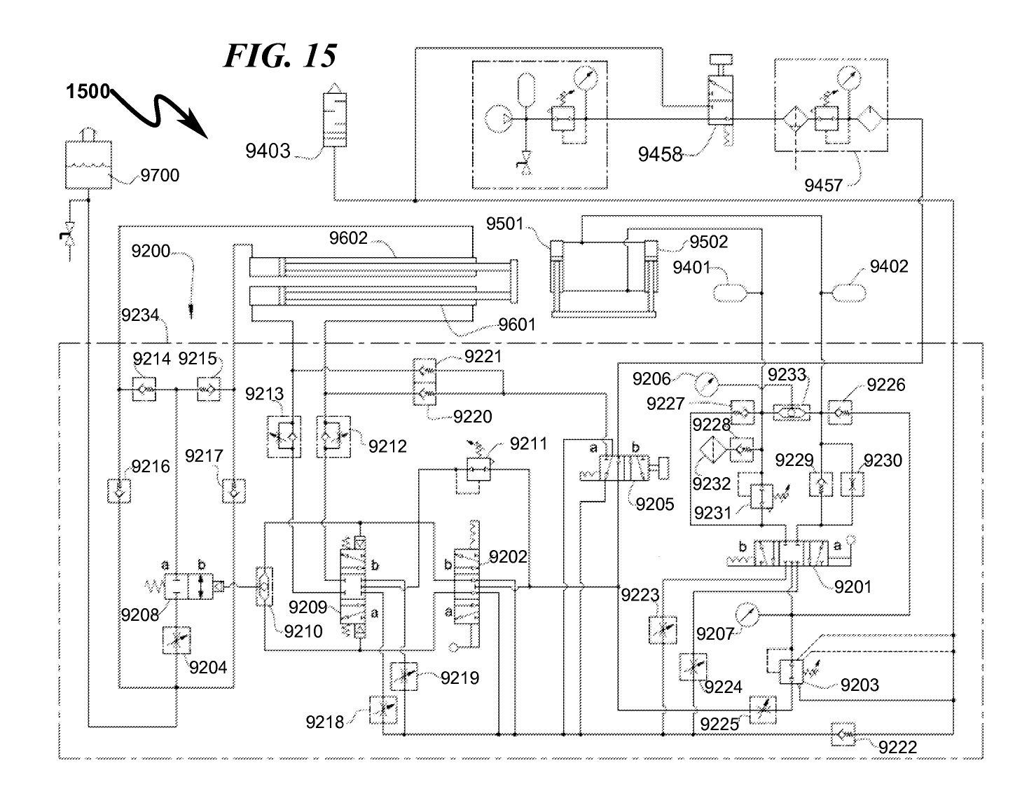

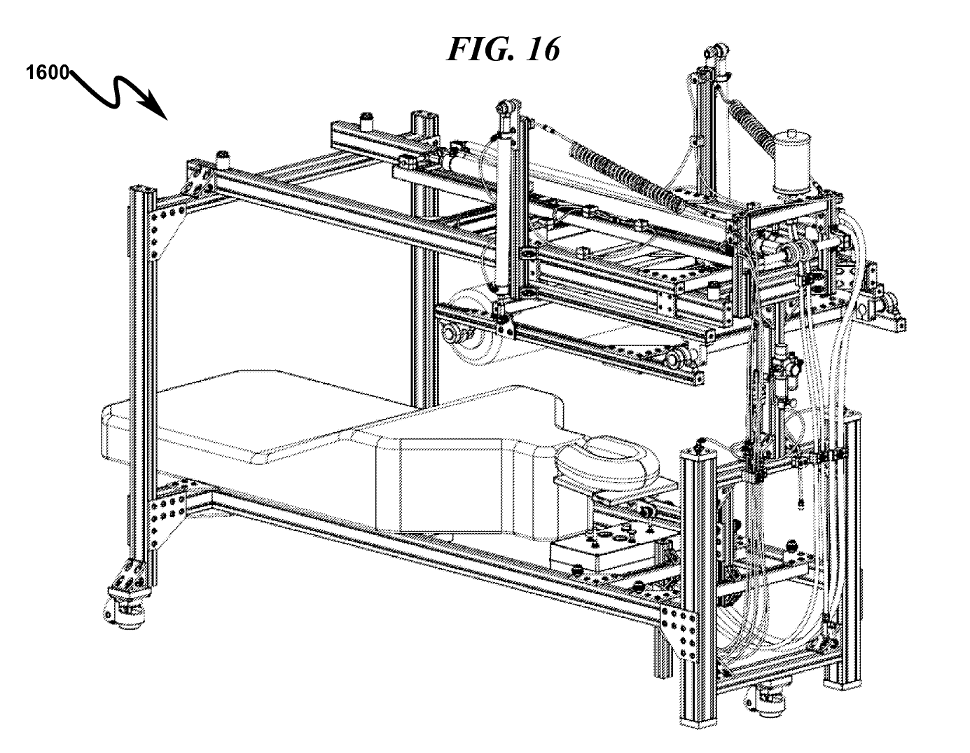

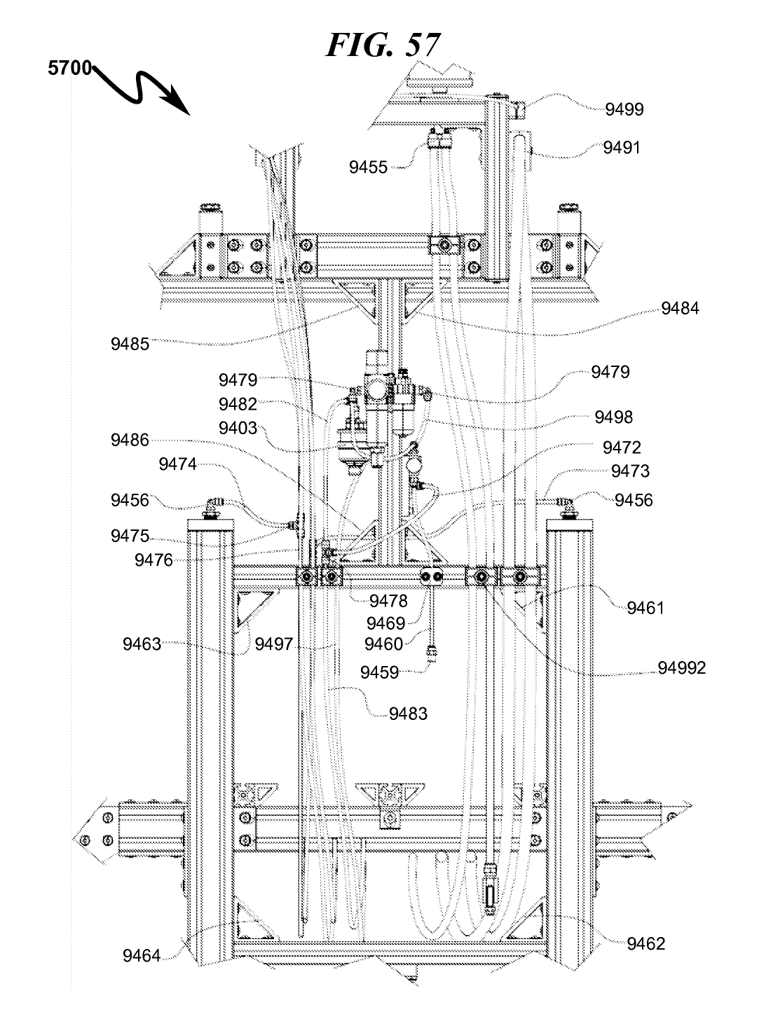

FIG. 15 (1500) illustrates an exemplary pneumatic schematic of a preferred exemplary invention embodiment used to control an exemplary manually controlled system as depicted in FIG. 16 (1600)-FIG. 57 (5700). One skilled in the art will recognize that the valves in this schematic may be electrically manipulated under computer control as generally depicted in the computerized CIB control system embodiment of FIG. 12 (1200).

### Exemplary Construction (1600)-(5700)

The pneumatic control schematic depicted in FIG. 15 (1500) may be combined with FIG. 16 (1600)-FIG. 57 (5700)

that depict construction of a preferred exemplary system embodiment wherein the construction of the embodiment has been accomplished using extruded aluminum such as is available from 80/20 Incorporated (1701 County Road 400 E, Columbia City, Ind. 46725, tel: (260) 248-8030).

### Illustration Views

A detailed preferred exemplary system embodiment as depicted in FIG. 16 (1600)-FIG. 57 (5700) may be considered as comprising a patient support table (9100), control box assembly (9200), face cradle assembly (9300), frame (9400), slide assembly (9500), horizontal cylinder assembly (9600), liquid reservoir (9700), and body contact assembly (9800).

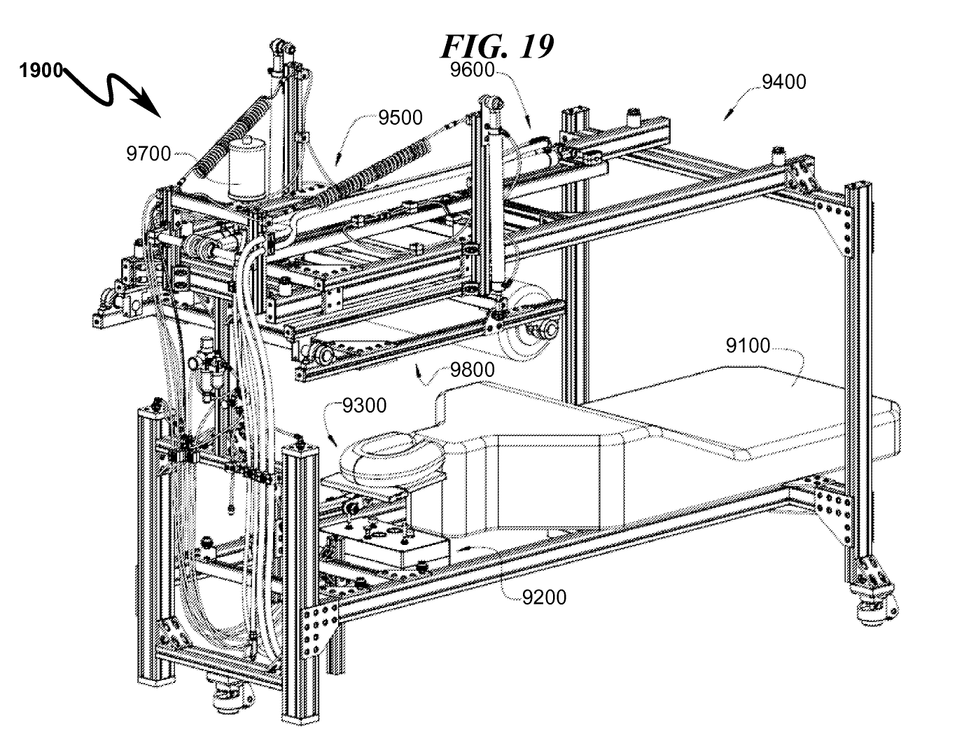

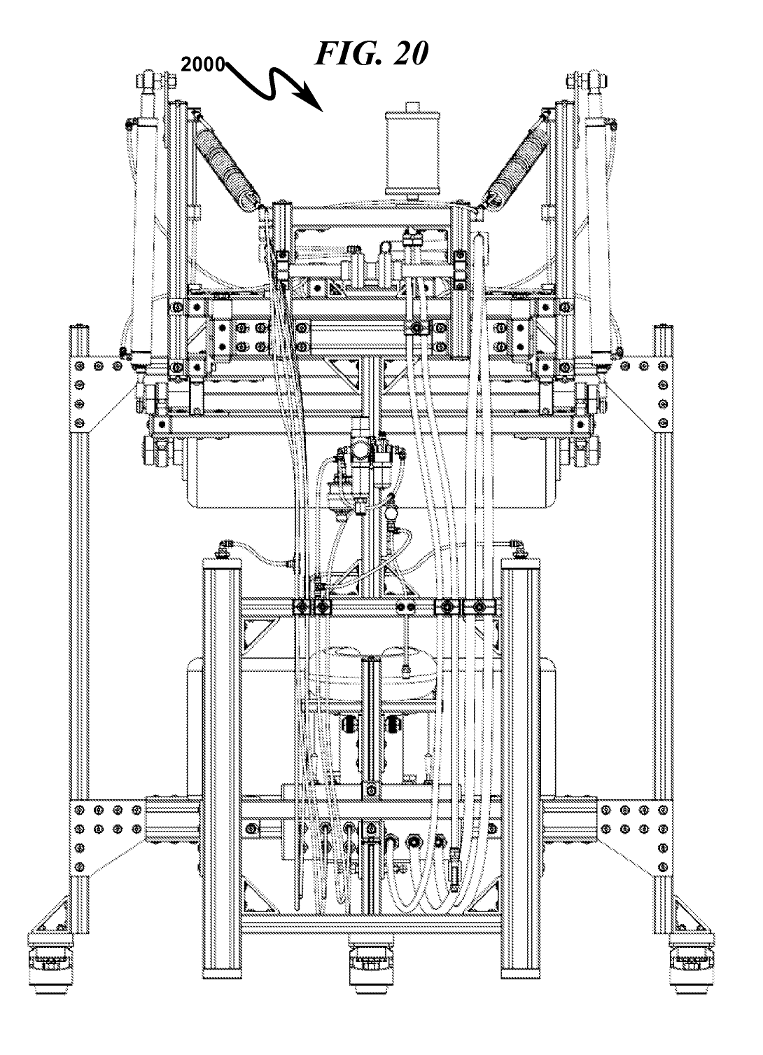

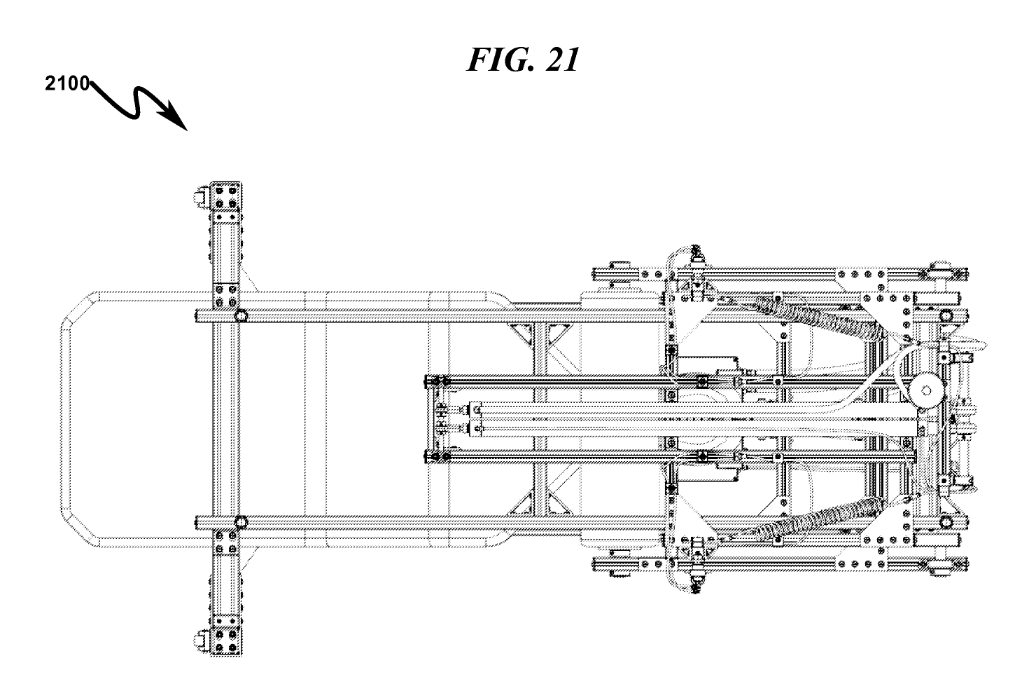

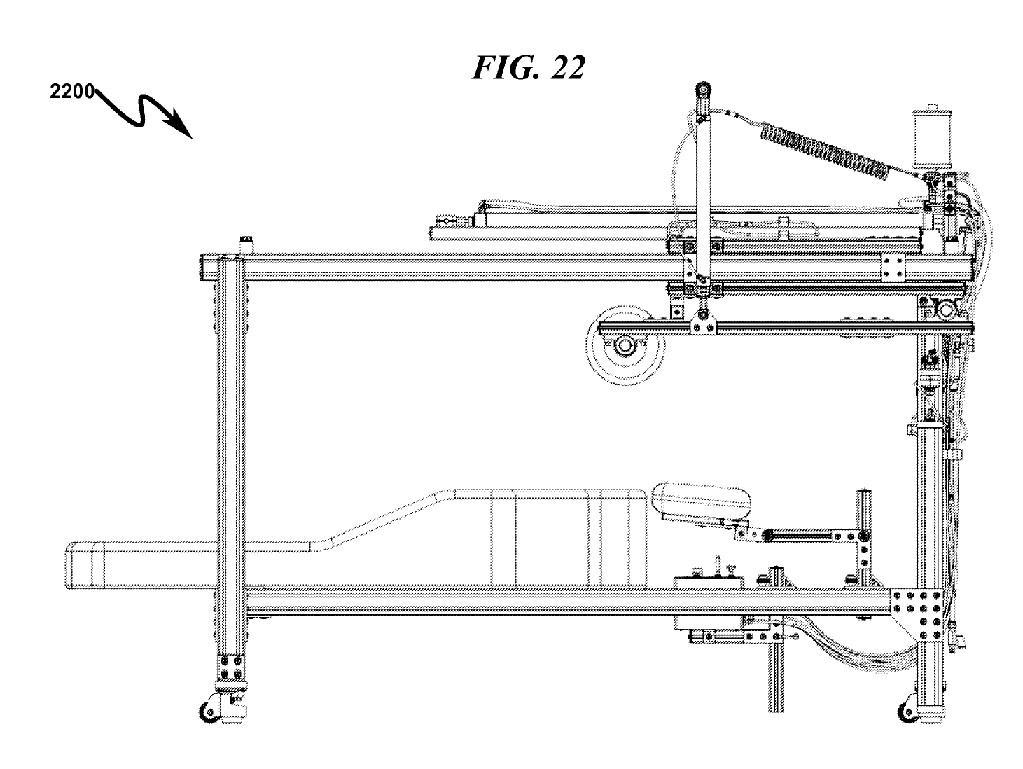

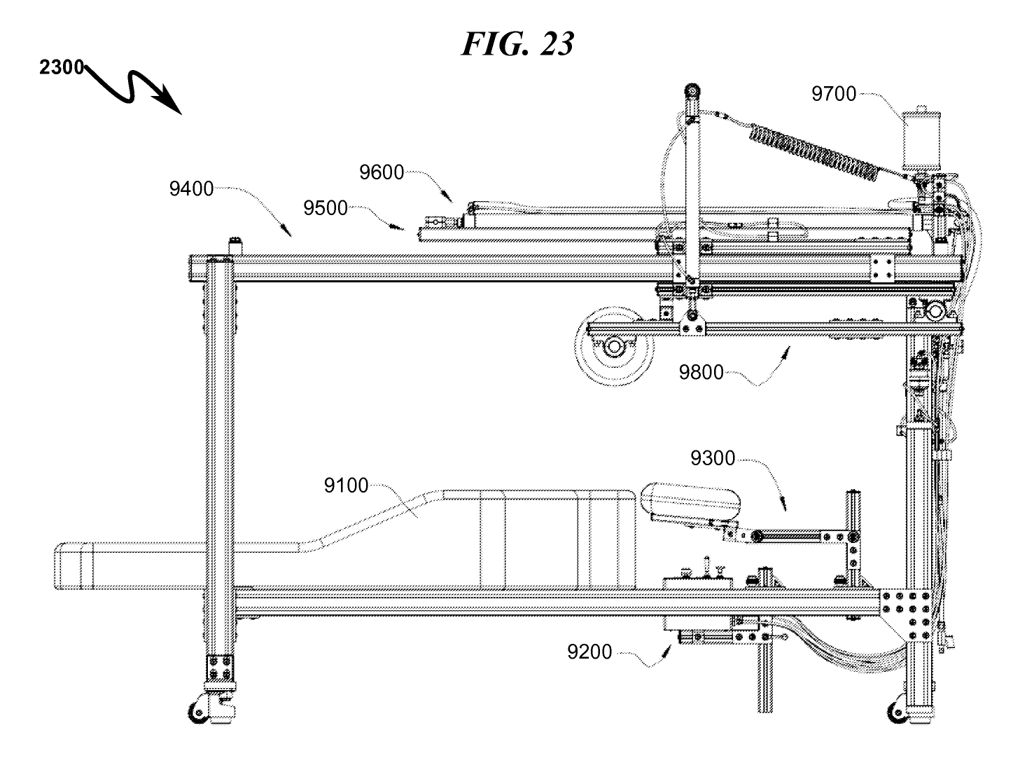

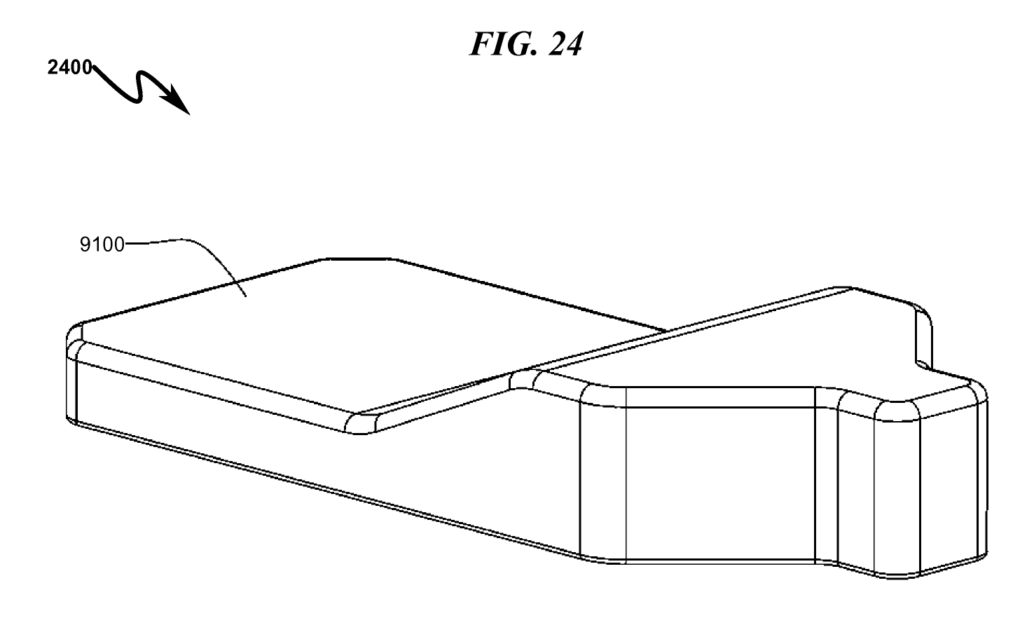

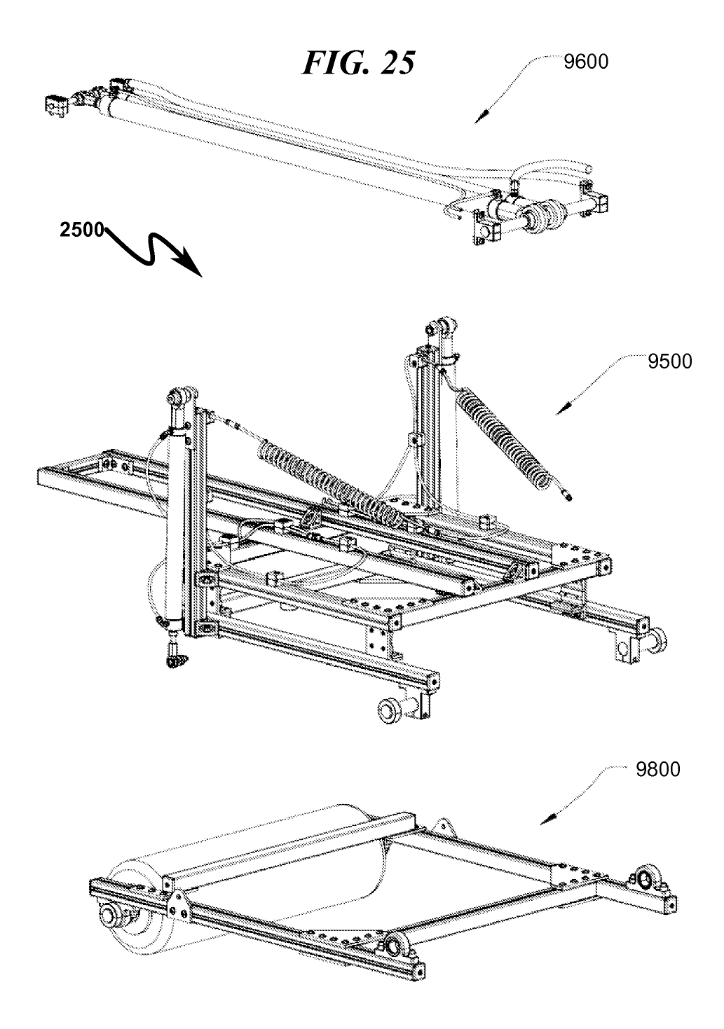

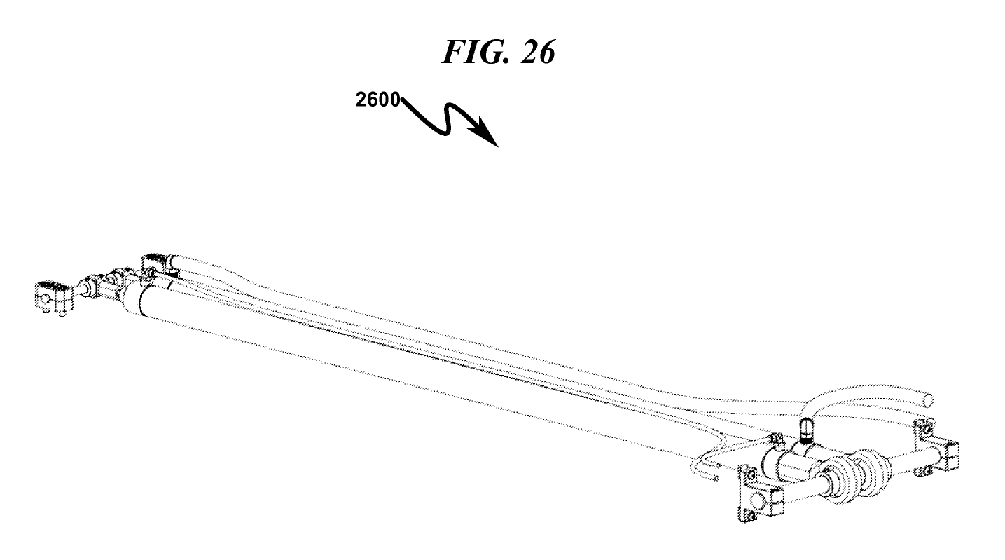

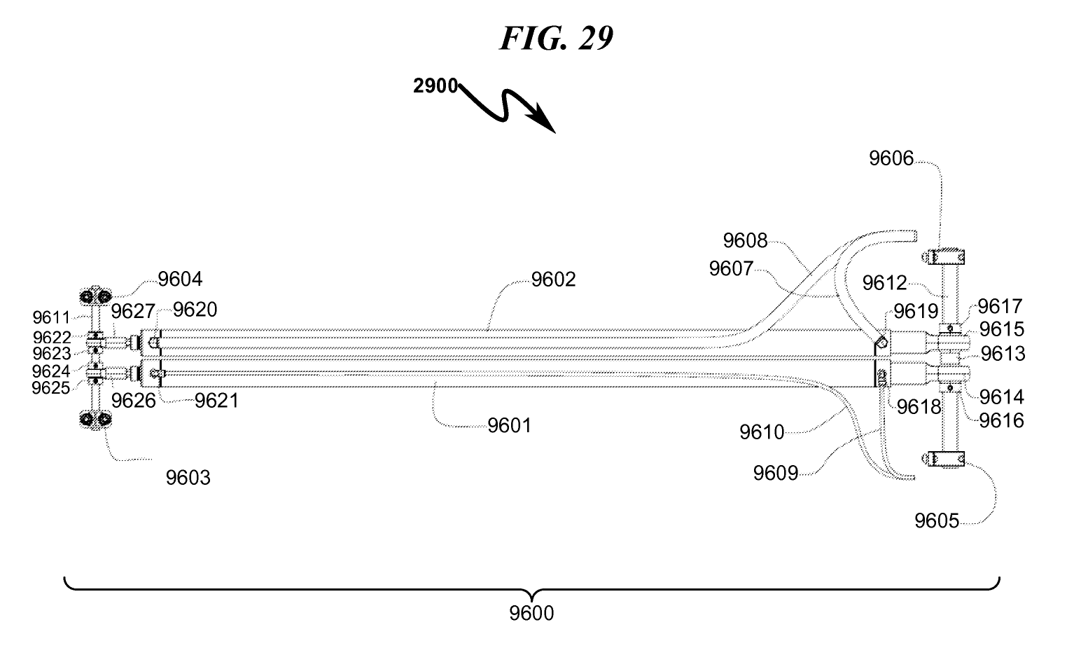

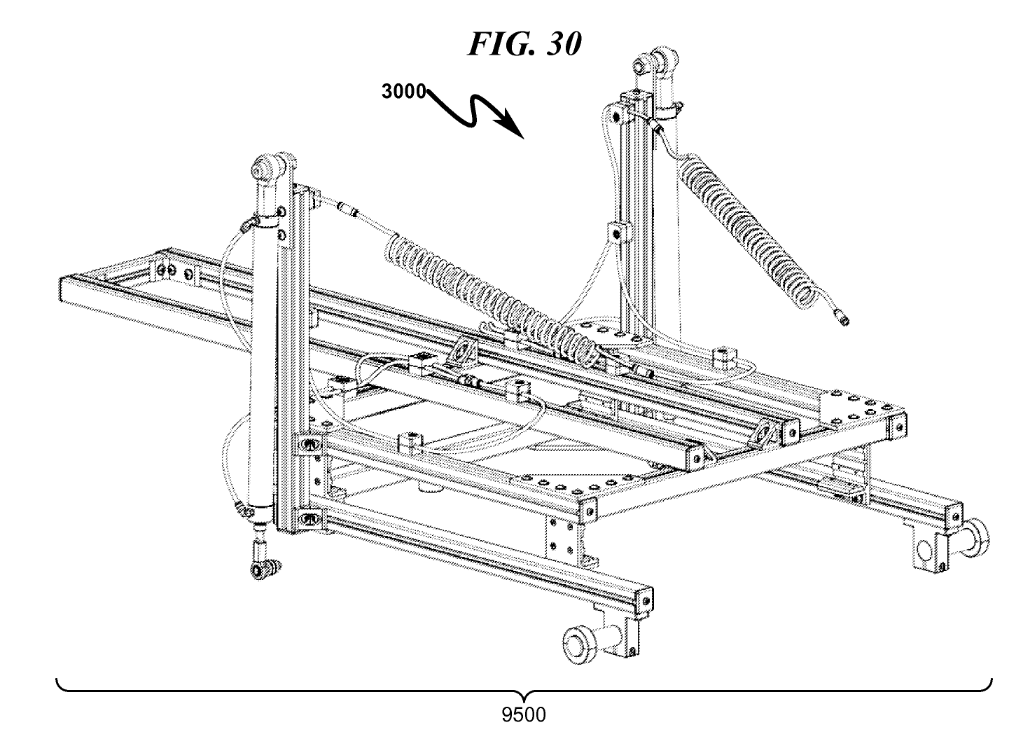

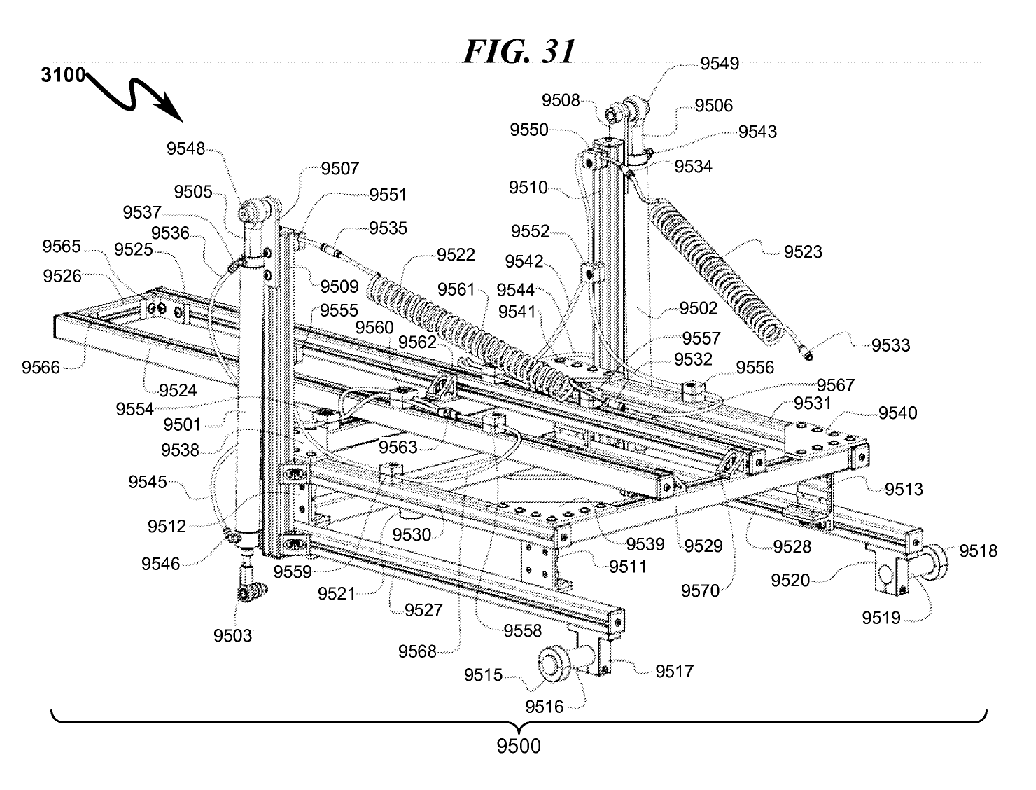

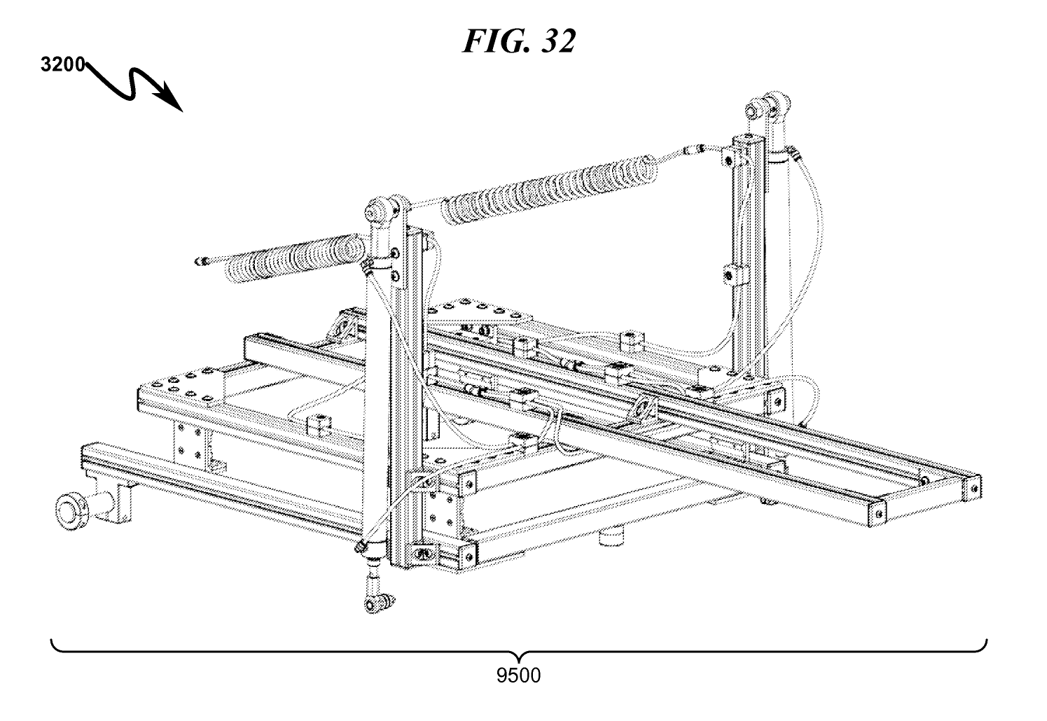

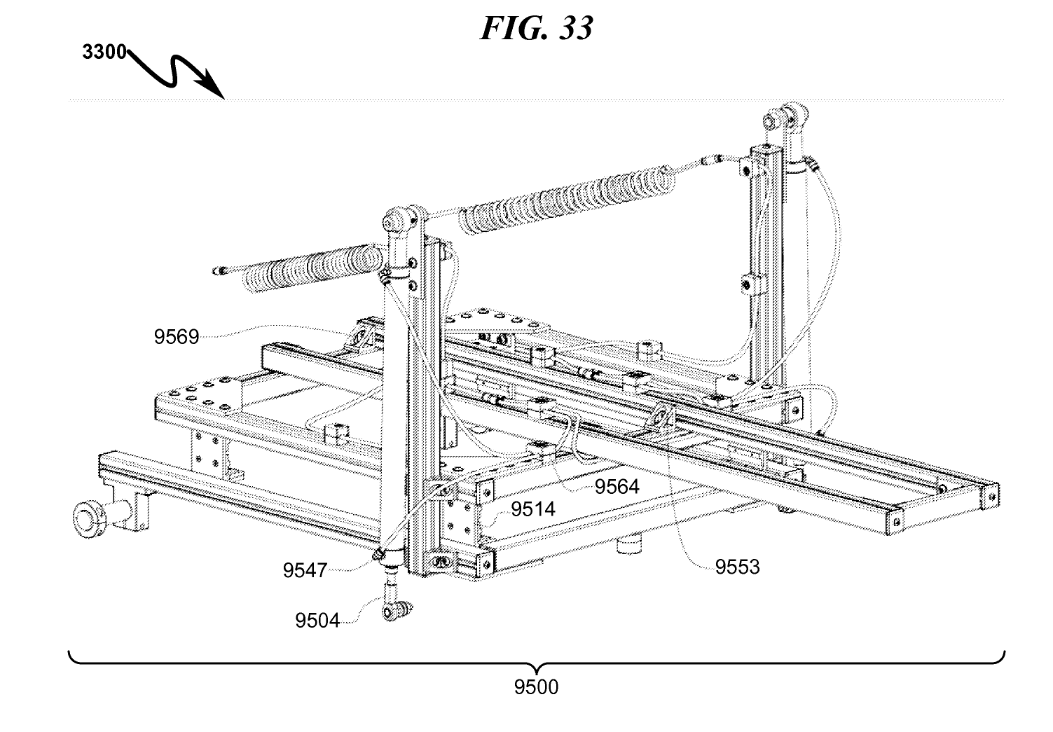

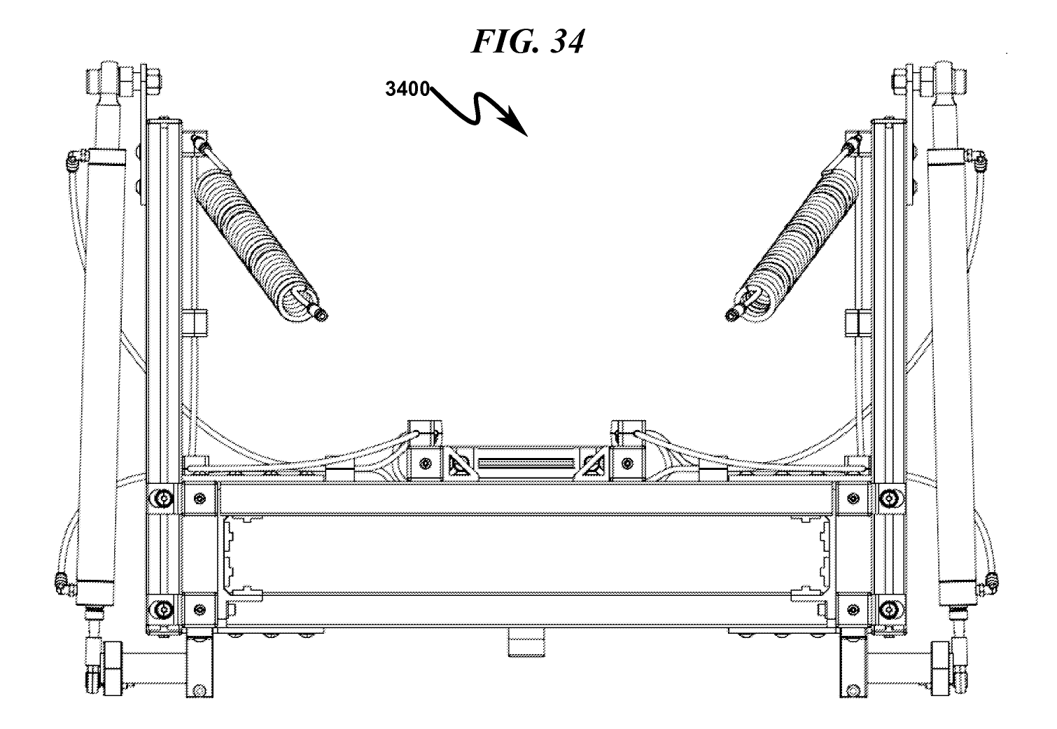

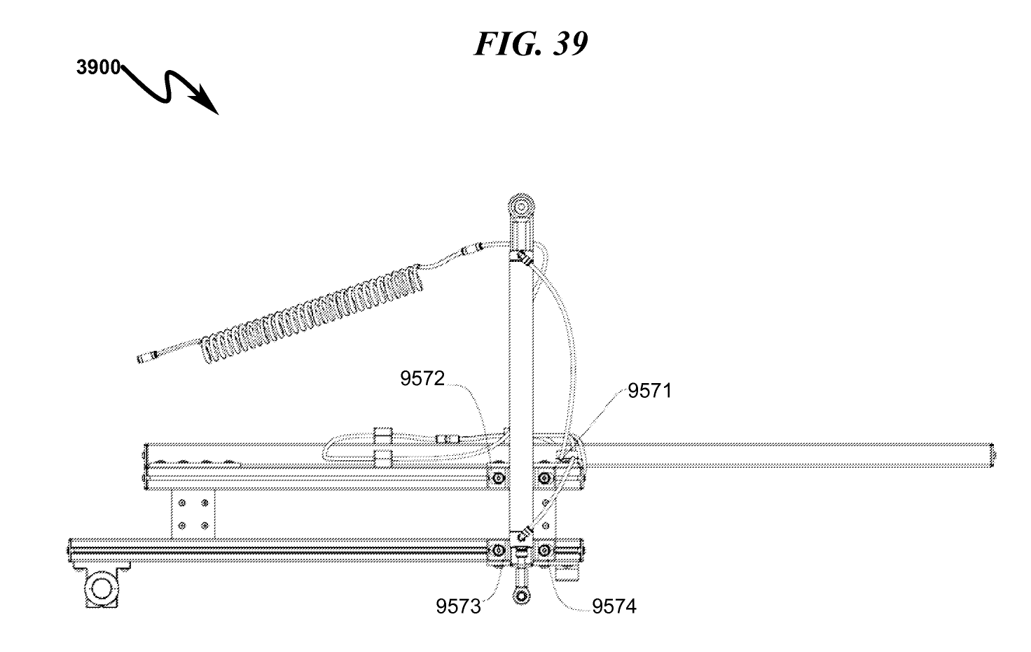

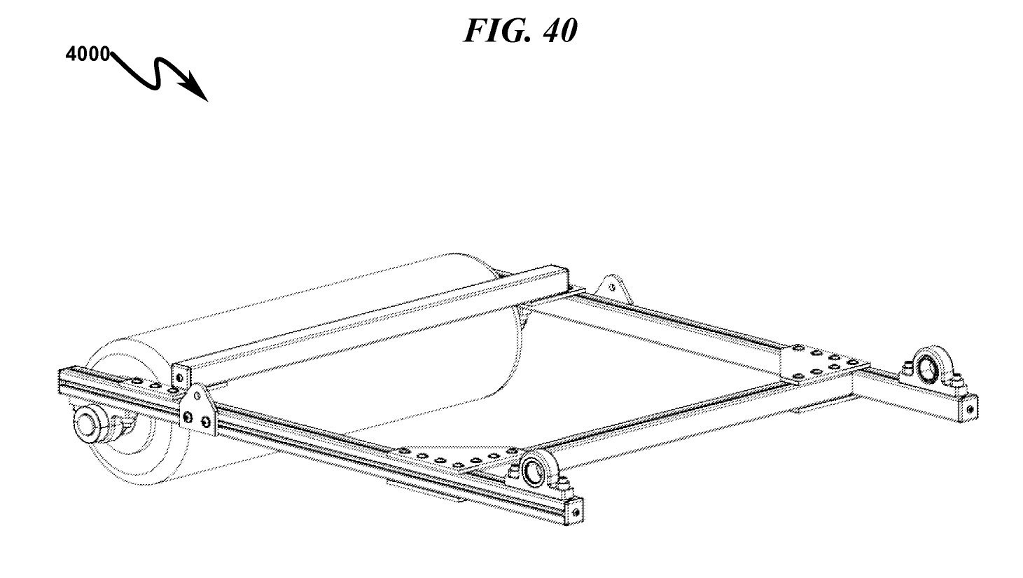

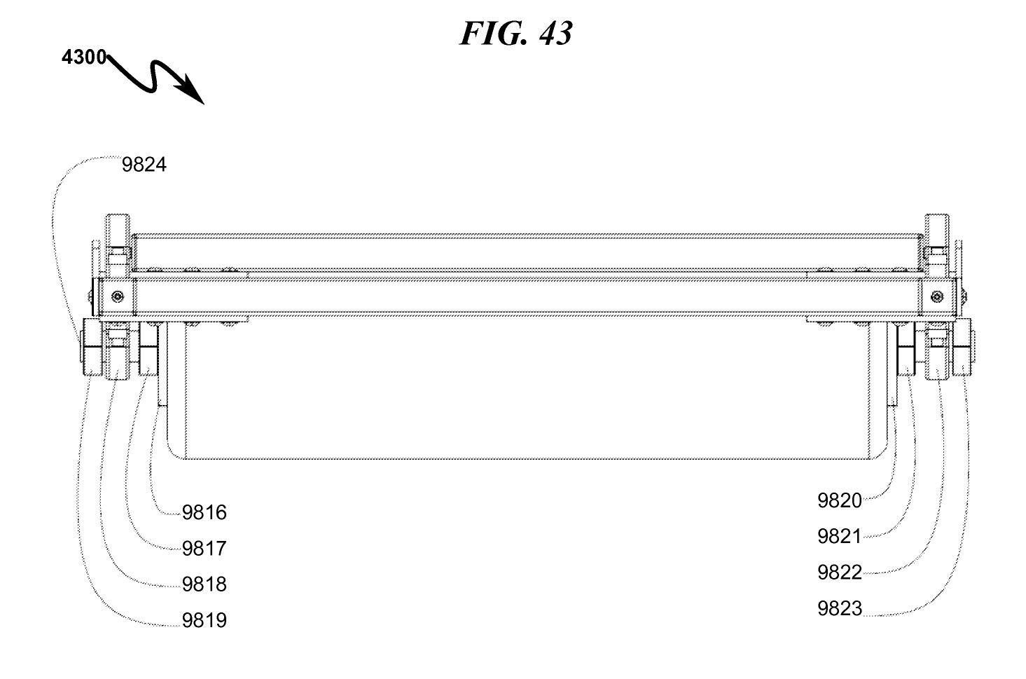

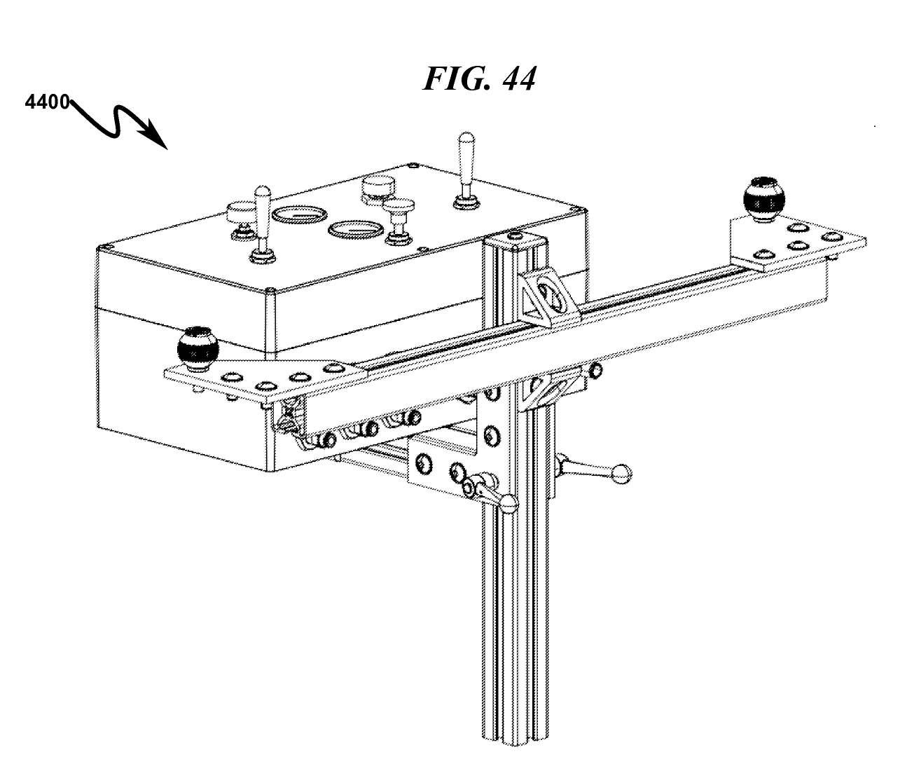

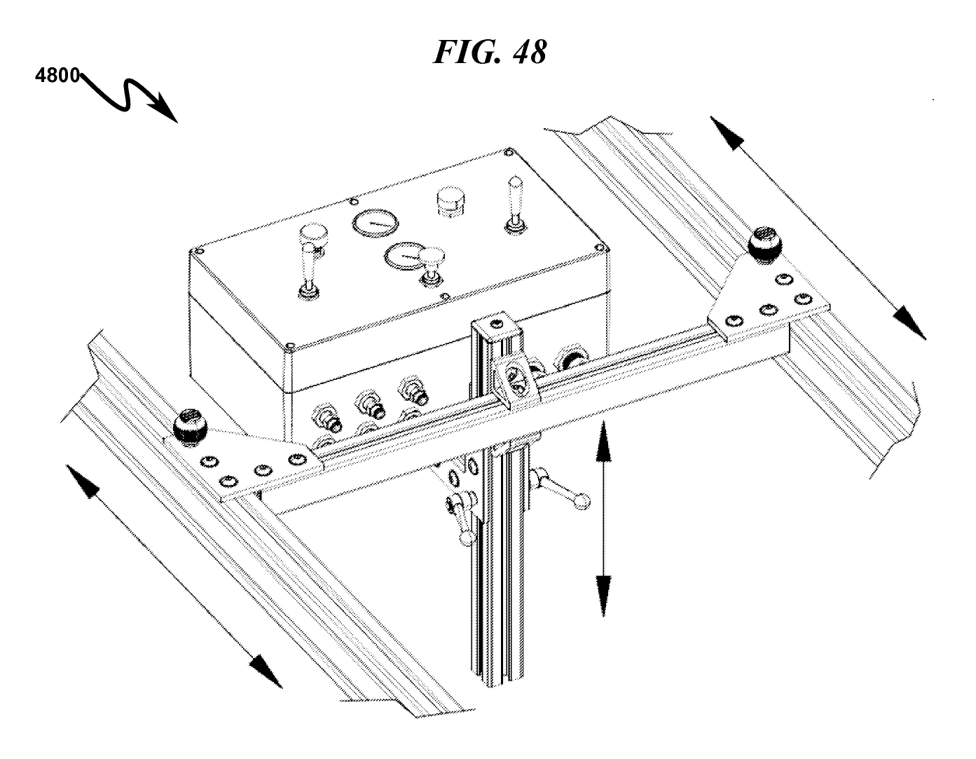

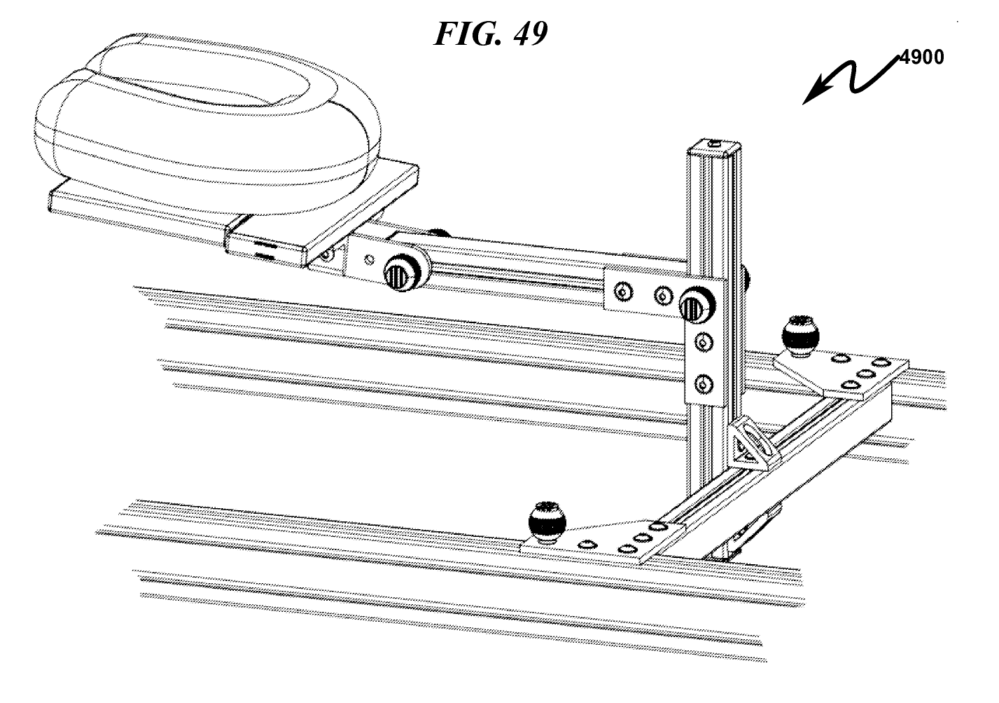

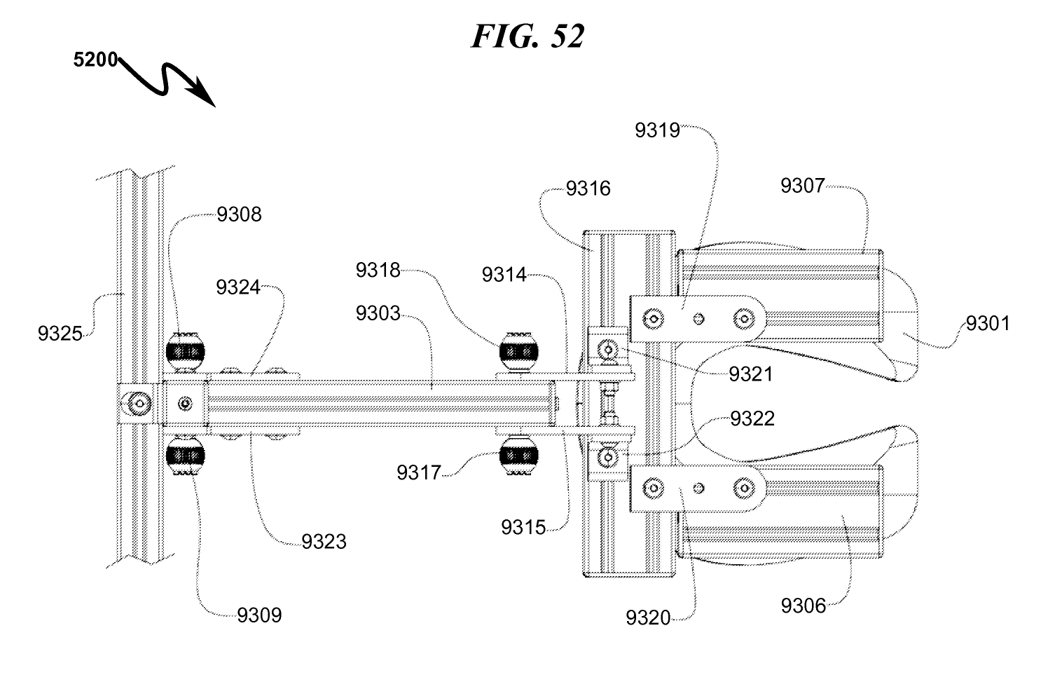

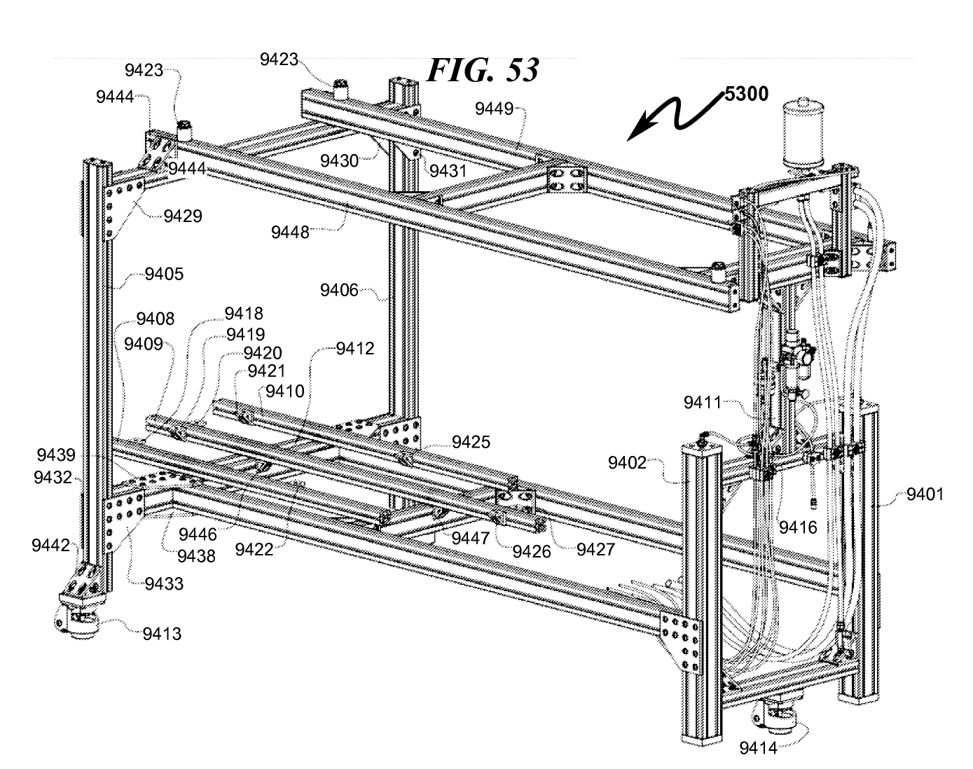

Within this combined exemplary embodiment construction context of FIG. 15 (1500)-FIG. 57 (5700), reference designators of the form “(9XXX)” generally refer to identical subsystem component identifiers “XXX” within this preferred embodiment. These various drawings are detailed as follows:
FIG. 16 (1600)-FIG. 19 (1900) provide several different perspective views of the invention embodiment;
FIG. 20 (2000)-FIG. 21 (2100) provide top and bottom views of the invention embodiment;
FIG. 22 (2200)-FIG. 23 (2300) provide side views of the invention embodiment;
FIG. 24 (2400) illustrates a perspective view of a typical PST;
FIG. 25 (2500) illustrates a perspective view of the HCA, HSA, and BCA subsystems;
FIG. 26 (2600)-FIG. 29 (2900) provide detail on a typical HCA subsystem;
FIG. 30 (3000)-FIG. 33 (3300) provide detail on a typical HSA subsystem and illustrate typical positional movement of the slide assembly (FIG. 30 (3000)-FIG. 31 (3100) and FIG. 32 (3200)-FIG. 33 (3300));
FIG. 34 (3400)-FIG. 39 (3900) illustrate various end, top, and side views of a typical HSA;
FIG. 40 (4000)-FIG. 43 (4300) provide detail on a typical BCA subsystem without the VCA positioning member;
FIG. 44 (4400)-FIG. 48 (4800) provide detail on a typical CIB subsystem and associated controls;
FIG. 49 (4900)-FIG. 52 (5200) provide detail on a typical PFC subsystem and associated adjustment controls; and
FIG. 53 (5300)-FIG. 57 (5700) provide detail on the FSS and associated adjustments for the PST and pneumatic controls.

One skilled in the art will recognize the depicted embodiment may be used in conjunction with the pneumatic schematic depicted in FIG. 15 (1500) to implement a control system incorporated within the CIB to permit patient/therapist control of the system as depicted to affect controlled pressure massage over predetermined regions of the patient's body.

### Exemplary Assembly

Within this context the following assembly details are relevant:
Patient support table (9100) bolts directly to frame (9400).
Control Box Assembly (9200) and Face Cradle Assembly (9300) mount on slotted extrusions (9404).
Slide assembly (9500) mounts and on slotted extrusions (9448, 9449) by means of plain bearings (9511, 9512, 9513, 9514).
The rod end of horizontal cylinder assembly (9600) bolts to the slide assembly (9500).
The blind end of horizontal cylinder assembly (9600) mounts to frame (9400).
On the pivoting end, the body contact assembly (9800) attaches to slide assembly (9500) by means of bearings (9802, 9803) and shafts (9516, 9519).
Vertical cylinders (9501, 9502) connect to body contact assembly (9800) by means of joining plates (9810, 9811) and rod ends (9503, 9504).
The blind end of cylinders (9501, 9502) attach to slide assembly (9500) by means of joining plates (9507, 9508).
Roller (9801) attaches to body contact assembly (9800) at bearings (9818, 9822).

### Exemplary Application Context (5800)-(6400)

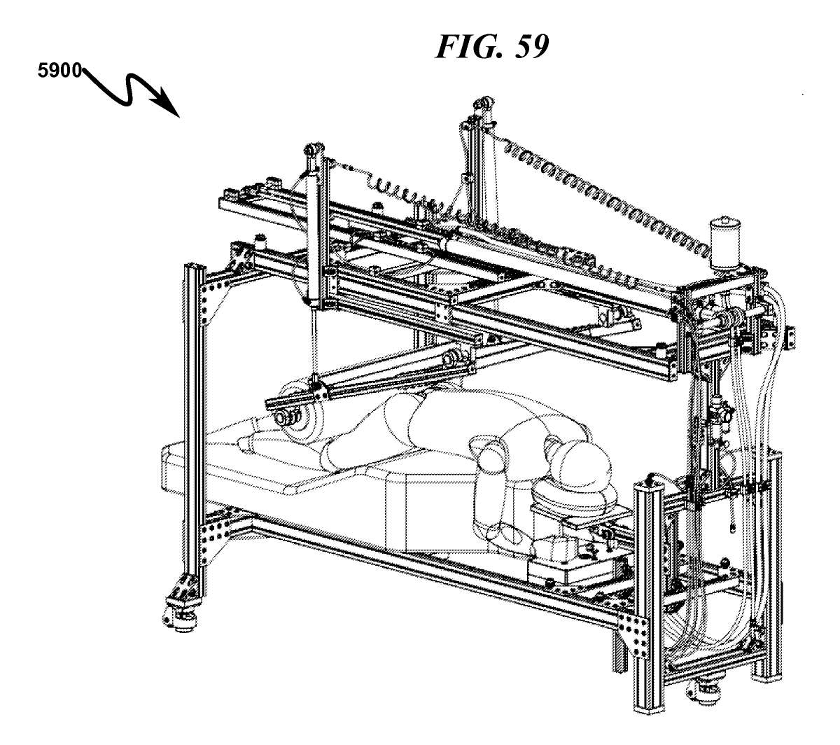

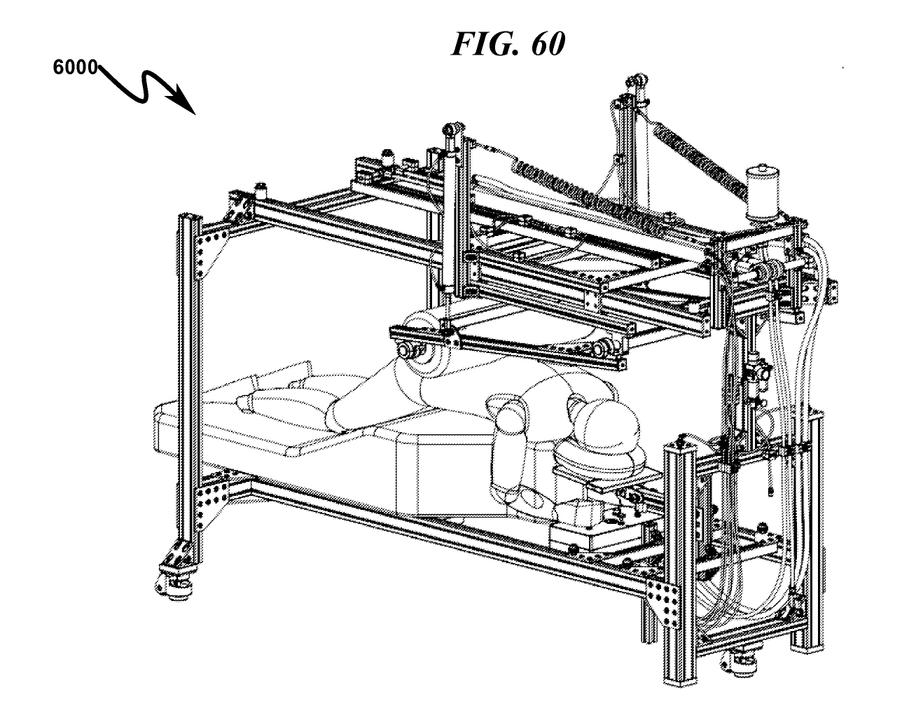

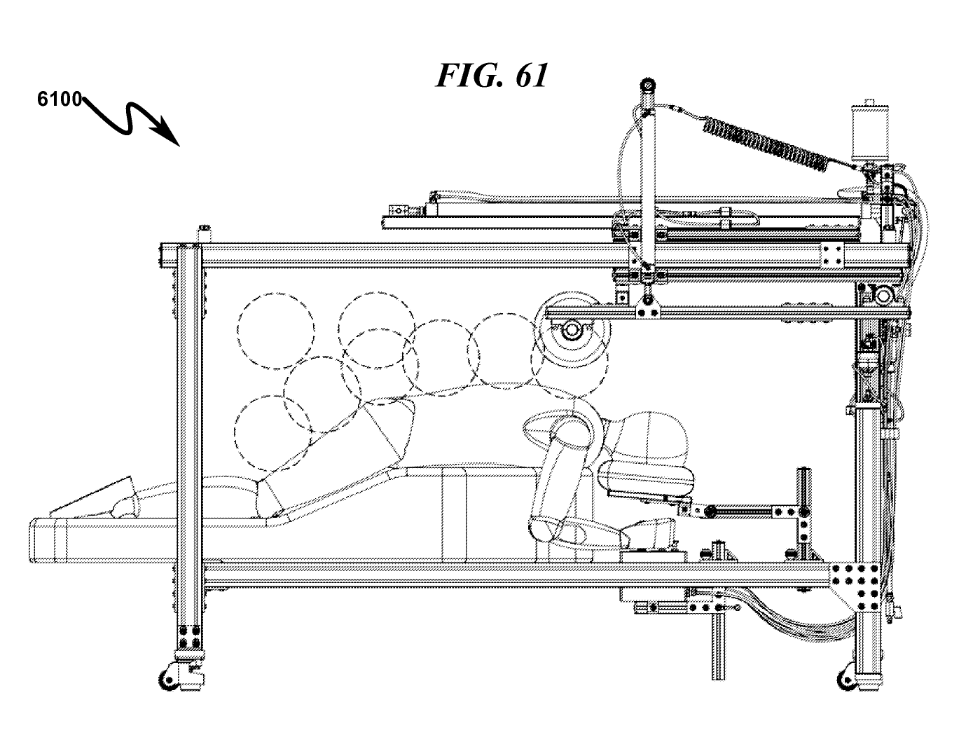

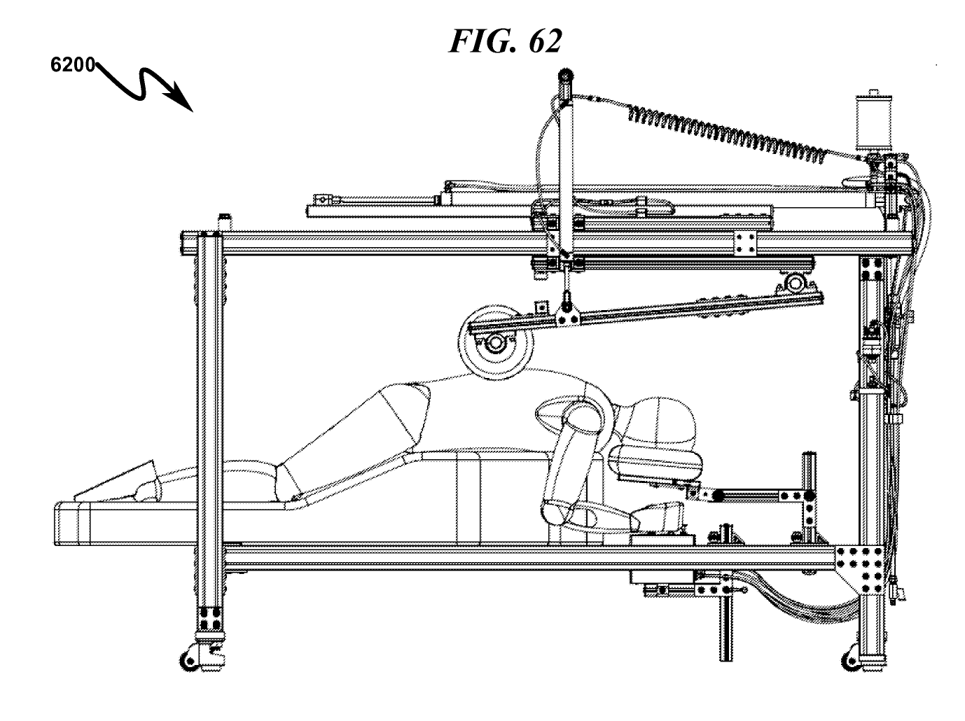

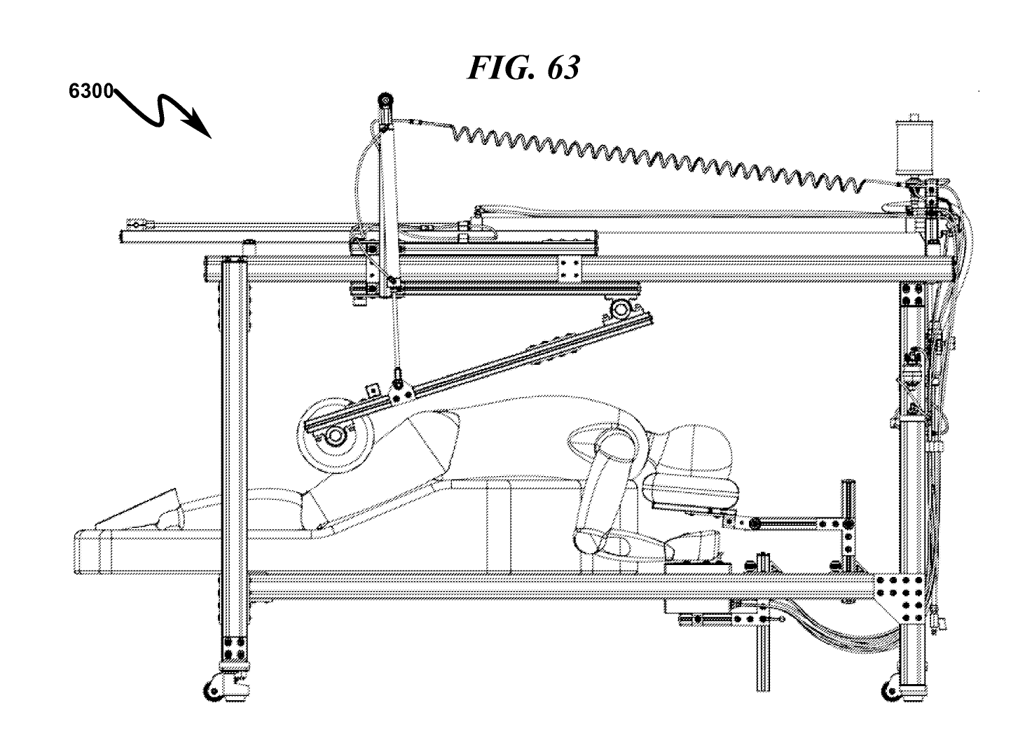

FIG. 58 (5800)-FIG. 64 (6400) depict a preferred exemplary system embodiment in a typical application context operating as follows:
FIG. 58 (5800) depicts the patient resting on the PST and PFC with the BCA retracted prior to massage therapy.
FIG. 59 (5900) depicts the patient receiving massage therapy via the BCA as the VCA is activated.
FIG. 60 (6000) depicts the patient receiving massage therapy via the BCA as the VCA is activated, and the HCA moves the HSA from the lower extremities of the patient to the patient back area.
FIG. 61 (6100) depicts a side view of the patient and various positions of the BCA as the VCA is activated/deactivated and the HCA positions the HSA along various portions of the patient.
FIG. 62 (6200)-FIG. 63 (6300) depict a side view of the patient receiving massage treatment with the BCA located at various positions of the along the patient as the VCA is activated to ensure a constant pressure is applied to the patient during the massage.
FIG. 64 (6400) depicts a side view of the patient after massage treatment is terminated and the BCA is retraced by the VCA and the HCA has positioned the HSA for the patient to exit the PST/PFC or initiate another massage session.

One skilled in the art will recognize that the CIB controls depicted may be positioned above the PST for access by massage therapy operator in situations where control of the patient massage is to be dictated by a therapist rather than the patient.

### Exemplary Patient Operation

Referring to FIG. 15 (1500)-FIG. 57 (5700), a patient mounts the machine with the body contact assembly (9800) in the “UP” position. In order to initiate massage therapy, the patient then pulls valve (9205) from position “B” to position “A.” Valve (9201) is then shifted from center position to position “A”, allowing compressed air to flow across metering orifice (9230), slowly filling the blind end of cylinders (9502, 9503), forcing body contact assembly (9800) downwards. Air chamber (9402) acts as a buffer to prevent sudden pressurization of the blind end of cylinders (9501, 9502).

Shifting valve (9201) to position “A” also causes air chamber (9401) to slowly depressurize, allowing body contact assembly (9800) to lower at a controlled rate (referring bearings (9802, 9803) pivot on shafts (9516, 9519)). The patient can adjust pressure being applied to the body by either adjusting pressure regulator (9203) or by throttling valve (9201). The patient can then proceed to move roller (9801) along the length of the body by shifting manual valve (9202) into either position “A” or “B”, which pilots valve (9209), moving cylinder (9601) rod either forward, reverse, or stopping it.

Liquid cylinder (9602) dampens horizontal movement via adjustable metering valve (9204). Valves (9214, 9215, 9216,

9217) rectify the liquid, allowing valve (9204) to be used as a single speed control for both horizontal directions. Valve (9208) is also piloted open when manual valve (9202) is shifted into position “A” or “B”, allowing liquid to be metered for speed control or locking the liquid in cylinder (9602), stopping horizontal movement.

The patient can see pressure gauges (9206, 9207) to select desired massage pressure. Gauge (9207) indicates where pressure regulator (9203) is set. Gauge (9206) shows the patient the actual pressure downstream of valve (9201).

When the patient is finished with a therapy session, the patient shifts valve (9201) into position “B”, raising body contact assembly (9800).

Once body contact assembly (9800) is in the “UP” position, the patient shifts valve (9201) into the centered position and pushes valve (9205) from position “A” to position “B”, and dismounts the machine. All exhaust air is sent through air muffler/filter (9403).

### Exemplary Invention Advantages

While the present invention may be constructed in a variety of embodiments, many of these embodiments support significant improvements over the prior art, including but not limited to the following:
Pneumatic Power. The use of pneumatic power for the present invention requires no electrical wiring to support the mechanics of the massage therapy and permits the compressor providing the compressed air to be remotely located.
Speed Control. A horizontal liquid damper cylinder may be mechanically linked to the horizontal pneumatic cylinder to provide speed control which permits very precise horizontal speed control of the body contact assembly from extremely slow speeds to higher speed operation. This is in contrast with the use of pneumatic cylinders as taught in the prior art which are by nature too unstable to provide this level of control.
Vertical Force Control. Pneumatic cylinders control the up and down movement and force of the body contact assembly. This allows variable or static pressure to be maintained while moving along the length and contours of the patient, providing for very light or deep pressure as required.
Patient Control. The control box assembly may be mounted directly below the face cradle assembly allowing the patient to be in complete control of the body contact assembly pressure, direction, speed, and position.
Safety. The control box assembly provides for additional safety by giving the patient easy visual access to the STOP button.
Patient Adjustments. The control box assembly permits patients of different sizes and builds to adjust the massage parameters accordingly.
Therapist Control. The control box assembly may be positioned on side of machine allowing the option of a therapist controlling the massage process.
Face Cradle. The adjustable face cradle assembly accommodates patients of different sizes and builds to accordingly adjust the massage therapy.
Position Limiters. Adjustable horizontal movement limiters permit horizontal movement to be restricted to within a limited range for safety.
Integrated Construction. The table, frame, and slide rails are integrated which permits increased massage table rigidity and allows for deeper massage without the need to bolt down the frame. This also permits the massage table to be portable, whereas bolt-down prior art systems must be used at a fixed location.
Patient Positioning. The present invention massage table system allows the patient to lie face down on machine. Since the patient is between the massaging contact means and the table, when applying deep tissue massage the patient's body will not be lifted upwards. This configuration also allows the massage contacting means to be applied to clothed or bare skin.

One skilled in the art will recognize that this list is non-exhaustive and may apply individually to a variety of invention embodiment subsets.

### System Summary

The present invention system anticipates a wide variety of variations in the basic theme of construction, but can be generalized as a massage table system comprising:
(a) frame support structure (FSS);
(b) patient support table (PST);
(c) patient face cradle (PFC);
(d) horizontal slide assembly (HSA);
(e) horizontal cylinder assembly (HCA);
(f) body contact assembly (BCA);
(g) vertical cylinder assembly (VCA); and
(h) control interface box (CIB);
wherein
the FSS is mechanically coupled to the PST and the PFC and configured to horizontally support the PST and the PFC;
the PST and the PFC are configured to support a patient with the face of the patient positioned against the top surface of the PFC and the frontal body of the patient positioned against the top surface of the PST;
the HCA is mechanically coupled to the FSS and configured to pneumatically position the HSA along the length of the FSS above the PST;
the HSA is mechanically coupled to the FSS and configured to horizontally position the BCA in response to activation of the HCA;
the BCA further comprises a patient massage roller (PMR) configured across the width of the FSS;
the PMR is configured to radially articulate from the HSA under pneumatic control of the VCA;
the CIB is mechanically coupled to the FSS;
the CIB is configured to direct the operation of the HCA in response to operator controls present on the CIB; and
the CIB is configured to direct the operation of the VCA in response to operator controls present on the CIB.

This general system summary may be augmented by the various elements described herein to produce a wide variety of invention embodiments consistent with this overall design description.

### Method Summary

The present invention method anticipates a wide variety of variations in the basic theme of implementation, but can be generalized as a massage table method comprising:
(1) mechanically coupling a frame support structure (FSS) to a patient support table (PST) and a patient face cradle (PFC) to horizontally support the PST and the PFC;
(2) configuring the PST and the PFC to support a patient with the face of the patient positioned against the top surface of the PFC and the frontal body of the patient positioned against the top surface of the PST;
(3) mechanically coupling a horizontal slide assembly (HSA) to the FSS;
(4) configuring a horizontal cylinder assembly (HCA) to affect horizontal movement of the HSA under pneumatic control;
(5) configuring the HSA to horizontally position a body contact assembly (BCA) along the length of the FSS above the PST under pneumatic control of the HCA;
(6) mechanically coupling a patient massage roller (PMR) across the width of the FSS to the BCA;
(7) configuring the PMR to radially articulate from the HSA under pneumatic control of a vertical cylinder assembly (VCA);
(8) mechanically coupling a control interface box (CIB) to the FSS;
(9) configuring the CIB to direct the operation of the HCA in response to operator controls present on the CIB; and
(10) configuring the CIB to direct the operation of the VCA in response to operator controls present on the CIB.

This general method summary may be augmented by the various elements described herein to produce a wide variety of invention embodiments consistent with this overall design description. This method may incorporate computerized control within the CIB to affect execution of pre-programmed massage therapies as well as modes in which massage therapies manually directed by a patient or therapist are stored for later application to the patient as single-event massage therapies or repeated massage therapies.

### Alternative Method Summary

An alternative present invention method incorporating computer control anticipates a wide variety of variations in the basic theme of implementation, but can be generalized as a massage table method wherein the method comprised is performed on a massage table system comprising:
(a) frame support structure (FSS);
(b) patient support table (PST);
(c) patient face cradle (PFC);
(d) horizontal slide assembly (HSA);
(e) horizontal cylinder assembly (HCA);
(f) body contact assembly (BCA);
(g) vertical cylinder assembly (VCA); and
(h) control interface box (CIB);
wherein
the FSS is mechanically coupled to the PST and the PFC and configured to horizontally support the PST and the PFC;
the PST and the PFC are configured to support a patient with the face of the patient positioned against the top surface of the PFC and the frontal body of the patient positioned against the top surface of the PST;
the HCA is mechanically coupled to the FSS and configured to pneumatically position the HSA along the length of the FSS above the PST;
the HSA is mechanically coupled to the FSS and configured to horizontally position the BCA in response to activation of the HCA;
the BCA further comprises a patient massage roller (PMR) configured across the width of the FSS;
the PMR is configured to radially articulate from the HSA under pneumatic control of the VCA; and
the CIB is mechanically coupled to the FSS.
wherein the method comprises the steps of:
(1) configuring the CIB to direct the operation of the HCA in response to operator controls present on the CIB; and
(2) configuring the CIB to direct the operation of the VCA in response to operator controls present on the CIB.

This general method summary may be augmented by the various elements described herein to produce a wide variety of invention embodiments consistent with this overall design description. This method may incorporate computerized control within the CIB to affect execution of pre-programmed massage therapies as well as modes in which massage therapies manually directed by a patient or therapist are stored for later application to the patient as single-event massage therapies or repeated massage therapies.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the BCA comprises a pad or multiple smaller rollers instead of a single roller.
An embodiment wherein the CIB is mounted on the side of machine for use by a physical therapist.
An embodiment wherein the CIB is configured to auto-cycle by adding pneumatic switches and modifying the pneumatic circuit.
An embodiment wherein a liquid cylinder with two pressurizable tanks may be used for HSA damping.
An embodiment wherein the CIB is adjustable in position and configured to (a) enable positioning proximal to the face cradle to permit operation of the CIB by the patient; or (b) enable positioning above the patient table to permit operation of the CIB by a massage therapist.
An embodiment wherein the HCA further comprises a liquid cylinder configured with a metering valve adjustable to dampen the activation of the HCA.
An embodiment wherein the CIB further comprises pressure gauges configured to monitor the pneumatic air pressure applied to the HCA.
An embodiment wherein the CIB further comprises pressure controls configured to adjust pneumatic air pressure applied to the HCA.
An embodiment wherein the CIB further comprises pressure gauges configured to monitor the pneumatic air pressure applied by the VCA to the BCA.
An embodiment wherein the CIB further comprises pressure controls configured to adjust pneumatic air pressure applied to the VCA.
An embodiment wherein the BCA comprises an additional patient contact roller (PCR) configured to operate independently in conjunction with a secondary VCA.
An embodiment wherein the CIB further comprises a computer system executing instructions from a computer readable medium, the computer system configured to execute preprogrammed operation of the HCA and the VCA to affect repeated massage of the patient via contact with the BCA.
An embodiment wherein the CIB further comprises a computer system configured to store inputs from the operator controls for subsequent operation of the HCA and the VCA to affect massage of the patient via contact with the BCA.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### Conclusion

A massage table system and method providing for self-application of adjustable compression and stretching has been disclosed. The system incorporates a frame support structure (FSS) that horizontally supports a patient support table (PST) and patient face cradle (PFC) configured to permit a massage patient to receive an adjustable massage from a body contact assembly (BCA) that is positioned using a horizontal slide assembly (HSA) under pneumatic control of a horizontal cylinder assembly (HCA). The patient is massaged via the use of a patient massage roller (PMR) radially articulated by the BCA in response to pneumatic pressure applied by a vertical cylinder assembly (VCA) while the BCA is positioned longitudinally over the patient by the HSA. A control interface box (CIB) provides adjustment of HSA travel speed and position as well as applied pressure to the PMR by the VCA. Computer controls within the CIB may permit automated patient massage procedures by pre-programmed or memorized operation of pneumatic valves controlling the HSA and BCA.

Although a preferred embodiment of the present invention has been illustrated in the accompanying drawings and described in the foregoing Detailed Description, it will be understood that the invention is not limited to the embodiments disclosed, but is capable of numerous rearrangements, modifications, and substitutions without departing from the spirit of the invention as set forth and defined by the following claims.

What is claimed is:

1. A massage table system comprising:
(a) frame support structure (FSS);
(b) patient support table (PST);
(c) patient face cradle (PFC);
(d) horizontal slide assembly (HSA);
(e) horizontal cylinder assembly (HCA);
(f) body contact assembly (BCA);
(g) vertical cylinder assembly (VCA); and
(h) control interface box (CIB);
wherein
said FSS is mechanically coupled to said PST and said PFC and configured to horizontally support said PST and said PFC;
said PST and said PFC are configured to support a patient with the face of said patient positioned against the top surface of said PFC and the frontal body of said patient positioned against the top surface of said PST;
said HCA is mechanically coupled to said FSS and configured to pneumatically position said HSA along the length of said FSS above said PST;
said HSA is mechanically coupled to said FSS and configured to horizontally position said BCA in response to activation of said HCA;
said BCA further comprises a patient massage roller (PMR) configured across the width of said FSS;
said PMR is configured to radially articulate from said HSA under pneumatic control of said VCA;
said CIB is mechanically coupled to said FSS;
said CIB is configured to direct the operation of said HCA in response to operator controls present on said CIB; and
said CIB is configured to direct the operation of said VCA in response to operator controls present on said CIB.

2. The massage table system of claim 1 wherein said CIB is adjustable in position and configured to (a) enable positioning proximal to said face cradle to permit operation of said CIB by said patient; or (b) enable positioning above said patient table to permit operation of said CIB by a massage therapist.

3. The massage table system of claim 1 wherein said HCA further comprises a liquid cylinder configured with a metering valve adjustable to dampen the activation of said HCA.

4. The massage table system of claim 1 wherein said CIB further comprises pressure gauges configured to monitor the pneumatic air pressure applied to said HCA.

5. The massage table system of claim 1 wherein said CIB further comprises pressure controls configured to adjust pneumatic air pressure applied to said HCA.

6. The massage table system of claim 1 wherein said CIB further comprises pressure gauges configured to monitor the pneumatic air pressure applied by said VCA to said BCA.

7. The massage table system of claim 1 wherein said CIB further comprises pressure controls configured to adjust pneumatic air pressure applied to said VCA.

8. The massage table system of claim 1 wherein said BCA comprises an additional patient contact roller (PCR) configured to operate independently in conjunction with a secondary VCA.

9. The massage table system of claim 1 wherein said CIB further comprises a computer system configured to execute preprogrammed operation of said HCA and said VCA to affect repeated massage of said patient via contact with said BCA.

10. The massage table system of claim 1 wherein said CIB further comprises a computer system configured to store inputs from said operator controls for subsequent operation of said HCA and said VCA to affect massage of said patient via contact with said BCA.

11. A massage table method comprising:
(1) mechanically coupling a frame support structure (FSS) to a patient support table (PST) and a patient face cradle (PFC) to horizontally support said PST and said PFC;
(2) configuring said PST and said PFC to support a patient with the face of said patient positioned against the top surface of said PFC and the frontal body of said patient positioned against the top surface of said PST;
(3) mechanically coupling a horizontal slide assembly (HSA) to said FSS;
(4) configuring a horizontal cylinder assembly (HCA) to affect horizontal movement of said HSA under pneumatic control;
(5) configuring said HSA to horizontally position a body contact assembly (BCA) along the length of said FSS above said PST under pneumatic control of said HCA;
(6) mechanically coupling a patient massage roller (PMR) across the width of said FSS to said BCA;
(7) configuring said PMR to radially articulate from said HSA under pneumatic control of a vertical cylinder assembly (VCA);
(8) mechanically coupling a control interface box (CIB) to said FSS;
(9) configuring said CIB to direct the operation of said HCA in response to operator controls present on said CIB; and
(10) configuring said CIB to direct the operation of said VCA in response to operator controls present on said CIB.

12. The massage table method of claim 11 wherein said CIB is adjustable in position and configured to (a) enable positioning proximal to said face cradle to permit operation of said CIB by said patient; or (b) enable positioning above said patient table to permit operation of said CIB by a massage therapist.

13. The massage table method of claim 11 wherein said HCA further comprises a liquid cylinder configured with a metering valve adjustable to dampen the activation of said HCA.

14. The massage table method of claim 11 wherein said CIB further comprises pressure gauges configured to monitor the pneumatic air pressure applied to said HCA.

15. The massage table method of claim 11 wherein said CIB further comprises pressure controls configured to adjust pneumatic air pressure applied to said HCA.

16. The massage table method of claim 11 wherein said CIB further comprises pressure gauges configured to monitor the pneumatic air pressure applied by said VCA to said BCA.

17. The massage table method of claim 11 wherein said CIB further comprises pressure controls configured to adjust pneumatic air pressure applied to said VCA.

18. The massage table method of claim 11 wherein said BCA comprises an additional patient contact roller (PCR) configured to operate independently in conjunction with a secondary VCA.

19. The massage table method of claim 11 wherein said CIB further comprises a computer system executing instructions from a computer readable medium, said computer system configured to execute preprogrammed operation of said HCA and said VCA to affect repeated massage of said patient via contact with said BCA.

20. The massage table method of claim 11 wherein said CIB further comprises a computer system configured to store inputs from said operator controls for subsequent operation of said HCA and said VCA to affect massage of said patient via contact with said BCA.

21. A tangible non-transitory computer usable medium having computer-readable program code means comprising a massage table method configured to operate on massage table system comprising:
(a) frame support structure (FSS);
(b) patient support table (PST);
(c) patient face cradle (PFC);
(d) horizontal slide assembly (HSA);
(e) horizontal cylinder assembly (HCA);
(f) body contact assembly (BCA);
(g) vertical cylinder assembly (VCA); and
(h) control interface box (CIB);
wherein
said FSS is mechanically coupled to said PST and said PFC and configured to horizontally support said PST and said PFC;
said PST and said PFC are configured to support a patient with the face of said patient positioned against the top surface of said PFC and the frontal body of said patient positioned against the top surface of said PST;
said HCA is mechanically coupled to said FSS and configured to pneumatically position said HSA along the length of said FSS above said PST;
said HSA is mechanically coupled to said FSS and configured to horizontally position said BCA in response to activation of said HCA;
said BCA further comprises a patient massage roller (PMR) configured across the width of said FSS;
said PMR is configured to radially articulate from said HSA under pneumatic control of said VCA;
said CIB is mechanically coupled to said FSS;
wherein said method comprises the steps of:
(1) configuring said CIB to direct the operation of said HCA in response to operator controls present on said CIB; and
(2) configuring said CIB to direct the operation of said VCA in response to operator controls present on said CIB.

22. The computer usable medium of claim 21 wherein said CIB is adjustable in position and configured to (a) enable positioning proximal to said face cradle to permit operation of said CIB by said patient; or (b) enable positioning above said patient table to permit operation of said CIB by a massage therapist.

23. The computer usable medium of claim 21 wherein said HCA further comprises a liquid cylinder configured with a metering valve adjustable to dampen the activation of said HCA.

24. The computer usable medium of claim 21 wherein said CIB further comprises pressure gauges configured to monitor the pneumatic air pressure applied to said HCA.

25. The computer usable medium of claim 21 wherein said CIB further comprises pressure controls configured to adjust pneumatic air pressure applied to said HCA.

26. The computer usable medium of claim 21 wherein said CIB further comprises pressure gauges configured to monitor the pneumatic air pressure applied by said VCA to said BCA.

27. The computer usable medium of claim 21 wherein said CIB further comprises pressure controls configured to adjust pneumatic air pressure applied to said VCA.

28. The computer usable medium of claim 21 wherein said BCA comprises an additional patient contact roller (PCR) configured to operate independently in conjunction with a secondary VCA.

29. The computer usable medium of claim 21 wherein said CIB further comprises a computer system executing instructions from a computer readable medium, said computer system configured to execute preprogrammed operation of said HCA and said VCA to affect repeated massage of said patient via contact with said BCA.

30. The computer usable medium of claim 21 wherein said CIB further comprises a computer system configured to store inputs from said operator controls for subsequent operation of said HCA and said VCA to affect massage of said patient via contact with said BCA.
